(19) United States
(12) Patent Application Publication
(10) Pub. No.: US 2019/0319519 A1
(43) Pub. Date: Oct. 17, 2019

(54) SYSTEM AND METHOD FOR INSERTING WIRE INTO STATOR CORE OF AC GENERATOR

(71) Applicant: Victory Industrial Corporation, New Taipei City (TW)

(72) Inventors: Chun-Yuan WANG, New Taipei City (TW); Yu-Tang KUAN, New Taipei City (TW)

(21) Appl. No.: 16/372,162

(22) Filed: Apr. 1, 2019

Related U.S. Application Data
(60) Provisional application No. 62/657,403, filed on Apr. 13, 2018.
(60) Provisional application No. 62/657,425, filed on Apr. 13, 2018.
(60) Provisional application No. 62/657,440, filed on Apr. 13, 2018.
(60) Provisional application No. 62/657,453, filed on Apr. 13, 2018.
(60) Provisional application No. 62/790,868, filed on Jan. 10, 2019.

(51) Int. Cl. H02K 15/06; H02K 1/16; H02K 3/12

(52) U.S. Cl. CPC H02K 15/065; H02K 3/12; H02K 1/16

(57) ABSTRACT

The present disclosure provides a system and a method for inserting a wire having a wavy shape into a stator core. The system includes a rotating receiver, a confining component, an expanding component and a pressing component. The rotating receiver is for rotating around an axis and receiving the wire. The rotating receiver includes multiple slots circumferentially disposed thereon. The slots extend along the axis. The confining component is for confining two adjacent linear segments of the wire separate within a space defined by the confining component. The expanding component is for adjusting the two adjacent linear segments so that they are separated from each other by a predetermined interval inside the space. The pressing component is for pressing the two linear segments into two of the multiple slots.

### CROSS REFERENCE TO RELATED APPLICATIONS

This applications claims the benefit of priority from the following US applications, each of which is herein incorporated by reference in their entirety for all purposes:

U.S. provisional patent application 62/657,403 filed Apr. 13, 2018;

U.S. provisional patent application 62/657,425 filed Apr. 13, 2018;

U.S. provisional patent application 62/657,440 filed Apr. 13, 2018;

U.S. provisional patent application 62/657,453 filed Apr. 13, 2018; and

U.S. provisional patent application 62/790,868 filed Jan. 10, 2019.

### TECHNICAL FIELD

The present disclosure generally relates to a system and a method for inserting wires into a stator core of an alternating current (AC) generator.

### BACKGROUND

An alternator is an electrical generator that converts mechanical energy into alternating-current electric energy. In a vehicle equipped with an alternator, induced current is generated by the combined operation of a stator and a rotor driven by an engine. When the engine operates, the rotor is accordingly driven to rotate via an alternator pulley coupled to the engine.

A stator may have several sets of wire coils wound around a stator core and surrounding the rotor. The stator is fixed to a housing of the alternator. As the rotor turns within the stator windings, the magnetic field of the rotor sweeps through the stator windings, producing an electromotive force that generates an alternative electrical current in the stator windings. This alternative electrical current is converted to a direct current through a rectifier and the direct electrical current is used to charge a battery for suppling power to other electrical parts in the vehicle. Hence, the mechanical energy generated from an engine is converted into the electrical energy by the use of the alternating-current alternator.

A conventional method for installing wire coils into a stator core requires a worker to manually position a wire in front of the slots of the stator core and a pressing component is actuated to press a segment of the wire into the slots. Then, the stator core is rotated and another segment of the wire is inserted into another slot by the pressing component. However, the worker may not precisely align each and every wire into slots of the stator especially when the worker has been working for a long period of time and is fatigued. Additionally, such method is costly and time-consuming given that the worker from time to time needs to adjust the position of the wire if the wire is not correctly inserted into the desired position in the corresponding slots of the stator.

What is needed, therefore, is a system and a method for inserting wires into a stator core with high precision and low cost.

### SUMMARY OF INVENTION

In accordance with an aspect of the present disclosure, a system for inserting a wire having a wavy shape into a stator core is provided. The system includes a rotating receiver, a confining component, an expanding component and a pressing component. The rotating receiver is for rotating around an axis and receiving the wire. The rotating receiver includes a plurality of slots circumferentially disposed thereon. The slots extend along the axis. The confining component is for confining two adjacent linear segments of the wire separate within a space defined by the confining component. The expanding component is for adjusting the two adjacent linear segments so that they are separated from each other by a predetermined interval inside the space. The pressing component is for pressing the two linear segments into two of the plurality of the slots.

In accordance with another aspect of the present disclosure, a method for inserting a wire having a wavy shape into a stator core is provided. The method includes the following steps: (a) moving the wire to a side of a rotating receiver having a plurality of slots so that two adjacent linear segments of the wire correspond to two of the plurality of slots; (b) adjusting the distance between the two linear segments so that they are separated by a predetermined interval; (c) inserting the two linear segments into the two slots of the rotating receiver; and (d) rotating the receiver in a first rotating direction so that another two adjacent linear segments of the wire correspond to other two of the plurality of slots.

In accordance with yet another aspect of the present disclosure, a method for inserting a first wire having a wavy shape and a second wire having a wavy shape into a stator core is provided. The method includes the following steps: (a′) moving the first wire to a side of a rotating receiver having a plurality of slots so that two first adjacent linear segments of a first portion of the first wire correspond to a first slot and a second slot of the plurality of slots; (b′) adjusting the distance between the two first linear segments so that they are separated by a predetermined interval; (c′) inserting the two first adjacent linear segments into the first slot and the second slot simultaneously; (d′) rotating the rotating receiver in a first rotating direction so that other two first linear segments of the first wire correspond to a third slot and a fourth slot of the plurality of slots; (e′) moving the second wire to the side of the rotating receiver so that two second linear segments of a second portion of the second wire correspond to a fifth slot and a sixth slot of the plurality of slots; (f′) adjusting the distance between the two second linear segments so that they are separated by the predetermined interval; (g′) inserting the two second adjacent linear segments into the fifth slot and the sixth slot of the plurality of slots; and (h′) rotating the rotating receiver in the first rotating direction so that other two second linear segments of the second wire correspond to a seventh slot and an eighth slot of the plurality of slots.

### BRIEF DESCRIPTION OF THE DRAWINGS

The invention as well as a preferred mode of use, further objectives, and advantages thereof will be best understood by referring to the following detailed description of illustrative embodiments in conjunction with the accompanying drawings, wherein:

FIGS. 1A-1C are illustrative top, front and right-side views of a system for inserting a wire into a stator core of an AC generator motor in accordance with an embodiment of the disclosure;

FIGS. 2A-2C are illustrative top, front and right-side views of the system showing a part of the wire being positioned between a pressing component and a rotating receiver in accordance with an embodiment of the disclosure;

FIGS. 3A-3C are illustrative top, front and right-side views of the system showing the portion of the wire being lifted in accordance with an embodiment of the disclosure;

FIGS. 4A-4C is a illustrative top, front and right-side views of the system showing the portion of the wire being confined within a space in accordance with an embodiment of the disclosure;

FIGS. 5A-5B are illustrative top and right-side views of the system showing the portion of the wire being pressed into two slots of the rotating receiver in accordance with an embodiment of the disclosure;

FIGS. 6 is an illustrative top view of the system showing the rotating receiver being rotated in accordance with an embodiment of the disclosure;

FIGS. 7A-7C are illustrative top, front and left-side views of the system showing a first portion of the wire being pressed into the rotating receiver in accordance with an embodiment of the disclosure;

FIGS. 8A-8C are illustrative top, front and left-side views of the system showing a second portion of the wire being in contact with a rotating component in accordance with an embodiment of the disclosure;

FIGS. 9A-9C are illustrative top, front and left-side views of the system showing the second portion of the wire being rotated by the rotating component in accordance with an embodiment of the disclosure;

FIGS. 10A-10B are illustrative top and front views of the system showing a second rail being moved towards the rotating receiver in accordance with an embodiment of the disclosure;

FIGS. 11A-11C are illustrative top, front and left-side views of the system showing the second rail being moved up to align the second portion of the wire with the first portion in accordance with an embodiment of the disclosure;

FIGS. 12A is an illustrative front views of the system showing the wire being inserted the stator core held by a lid in accordance with an embodiment of the disclosure;

FIGS. 12B is a top view of the lid that houses the stator core and the disk in accordance with an embodiment of the disclosure;

FIGS. 13A-13B are illustrative top and front views of a system for inserting two wires wire into a stator core of an AC generator motor in accordance with an embodiment of the disclosure; and

FIG. 14 is a perspective view of a stator core with multiple wires inserted into multiple slots.

### DETAILED DESCRIPTION

The characteristics, subject matter, advantages, and effects of the present disclosure are detailed hereinafter by reference to embodiments of the present disclosure and the accompanying drawings. It is understood that the drawings referred to in the following description are intended only for purposes of illustration and do not necessarily show the actual proportion and precise arrangement of the embodiments. Therefore, the proportion and arrangement shown in the drawings should not be construed as limiting or restricting the scope of the present invention.

The terminology used in the description of the present disclosure herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

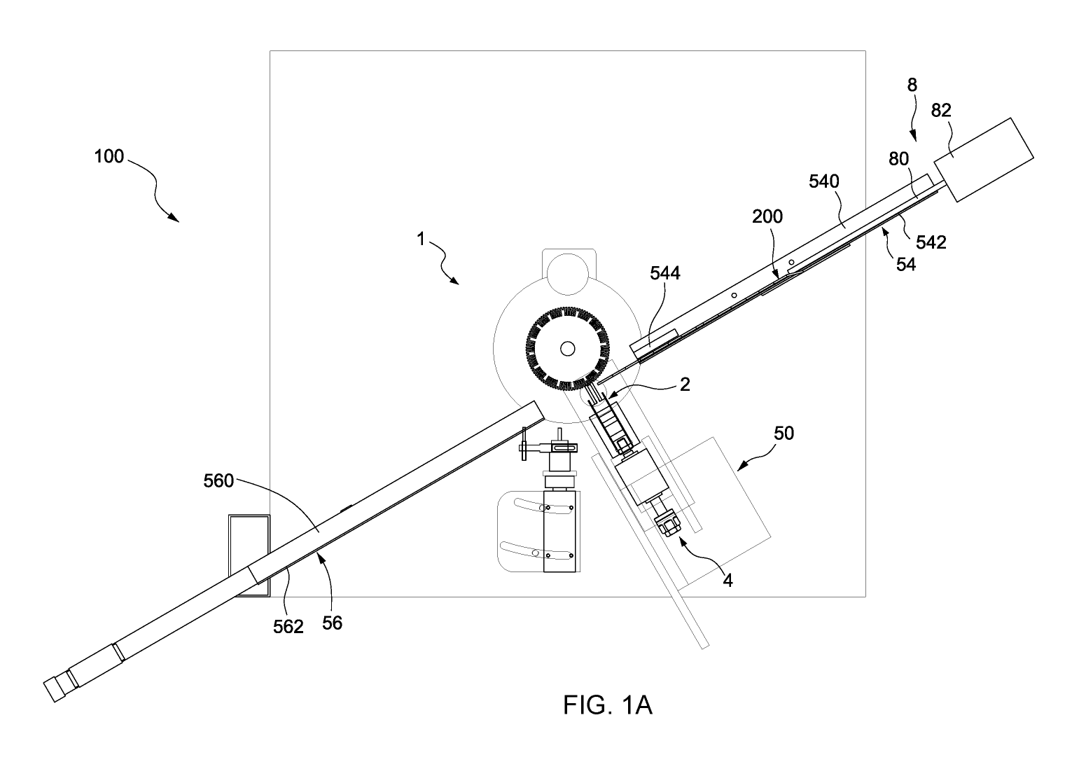

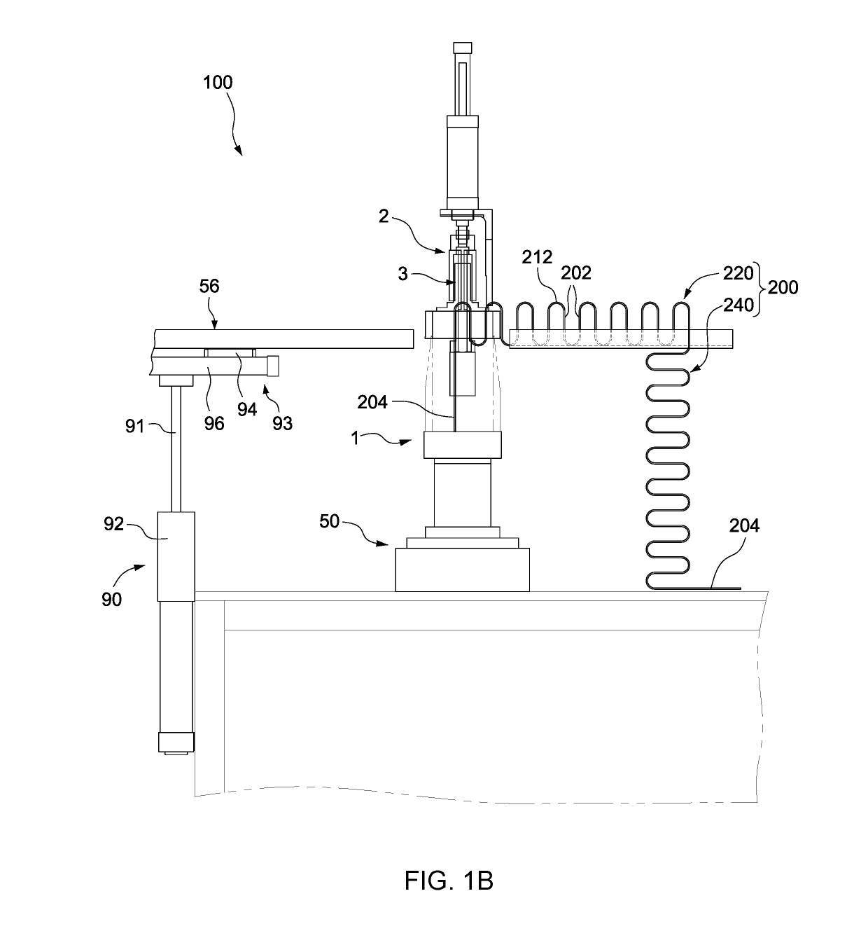

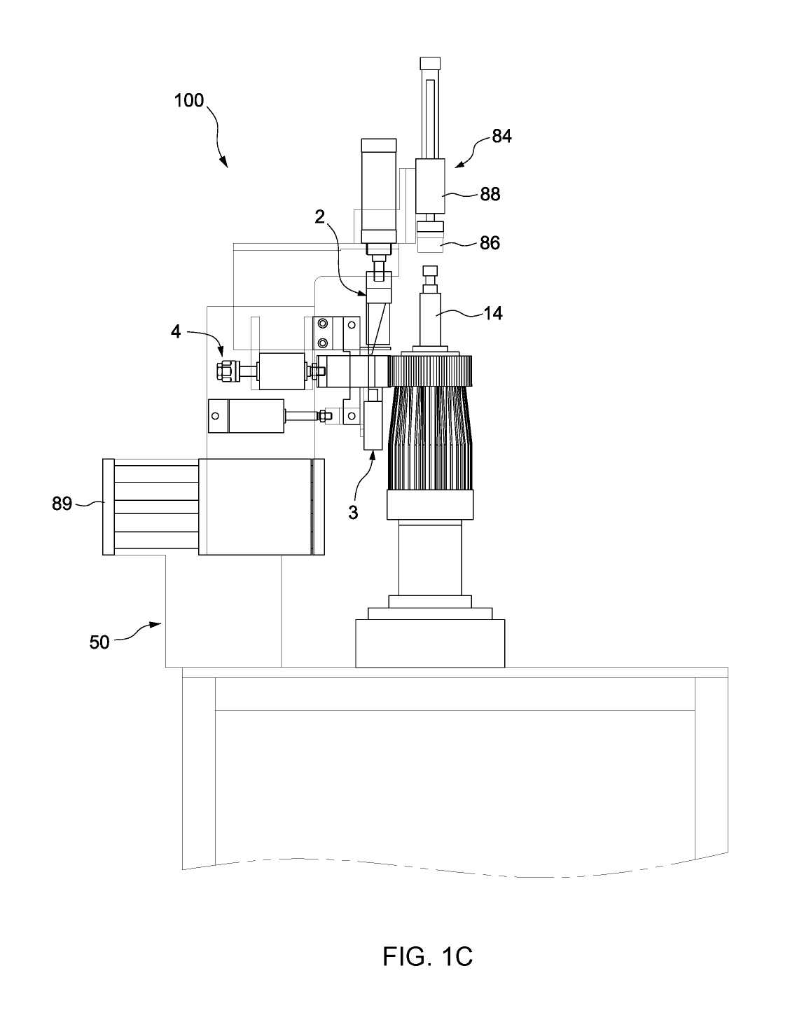

Referring FIGS. 1A-1C, the present disclosure provides a system 100 for inserting wires 200 into a stator core of an alternating current (AC) generator (i.e., an alternator) to form a stator. In some embodiments, the wound stator is installed with a rotor, a housing and several parts, such as rectifier, to form an alternator. The AC generator may be equipped in a vehicle, for example, a car, a forklift, a hoist, a lawn mower, or the like, with a view to providing direct electrical current through a rectifier that convers AC electrical current into DC electrical current, to several electronical parts installed in the vehicle, such as lamp, infrared sensor, air conditioner, radio, rear-view camera, and the like.

The stator has several sets of wire coils wound around a stator core that surrounds the rotor. The stator core in one embodiment is cylindrical in shape and has numerous tooth portions formed on the circumference surface of its core body. The tooth portions of the stator extend from the core body towards the axis A1 of the rotor. Numerous slots are defined between every two adjacent tooth portions, respectively. The wires are inserted into the slots and wound around the tooth portions to form several different phases of coils. Then, the coils may be connected to a rectifier configured to convert a direct current into an alternate current.

The following describes a system 100 for inserting wires 200 into a stator core of an AC generator. As shown in FIG. 1B, the wire 200 is wavy-shaped and includes multiple sinusoidal curved segments 212 that may be formed by bending a straight wire 200 using a bending machine and multiple linear segments 202 each connecting two of the sinusoidal curved segments 212. The two ends of the wire 200 may be two linear segments 204 with its lengths being greater than other linear segments 202 of the wire 200.

As shown in FIGS. 1A-1C, in accordance with one embodiment of the present disclosure, the system 100 includes a rotating receiver 1, a confining component 2, an expanding component 3 and a pressing component 4. The system 100 further includes a base 50 on which the confining component 2, the expanding component 3 and the pressing component 4 are disposed. The base 50 is separated from the rotating receiver 1 by a distance.

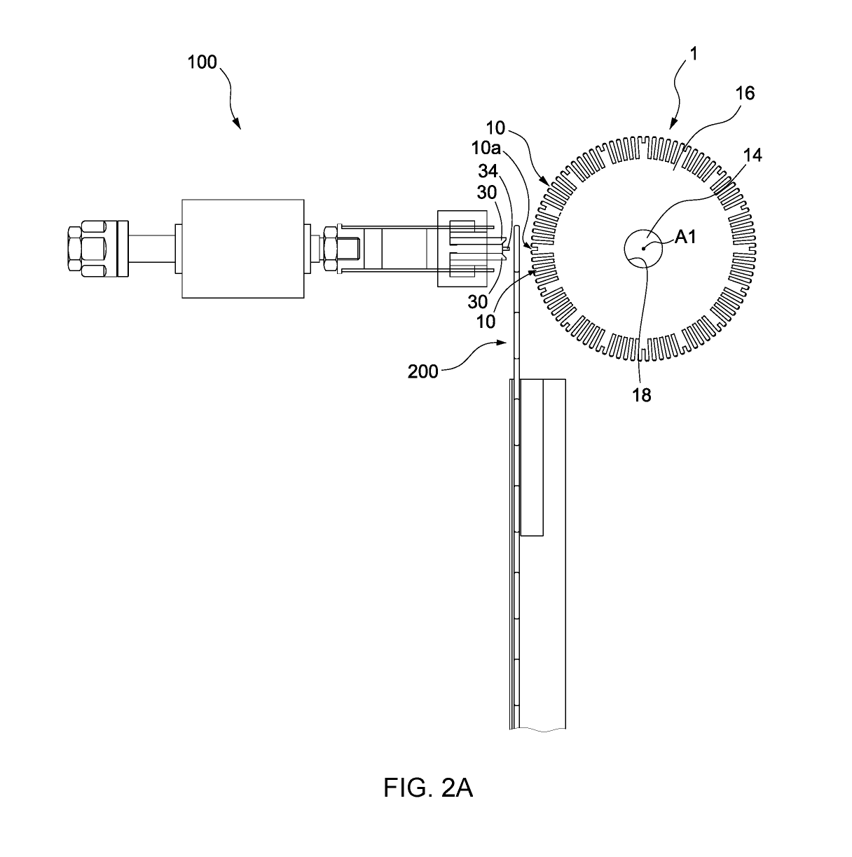

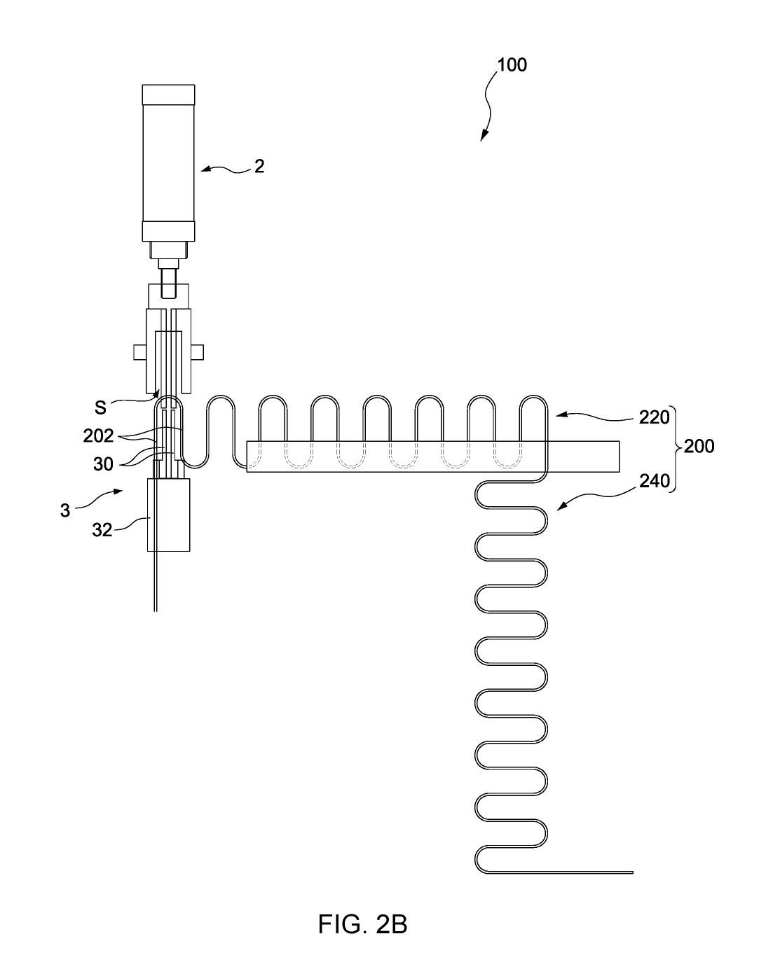

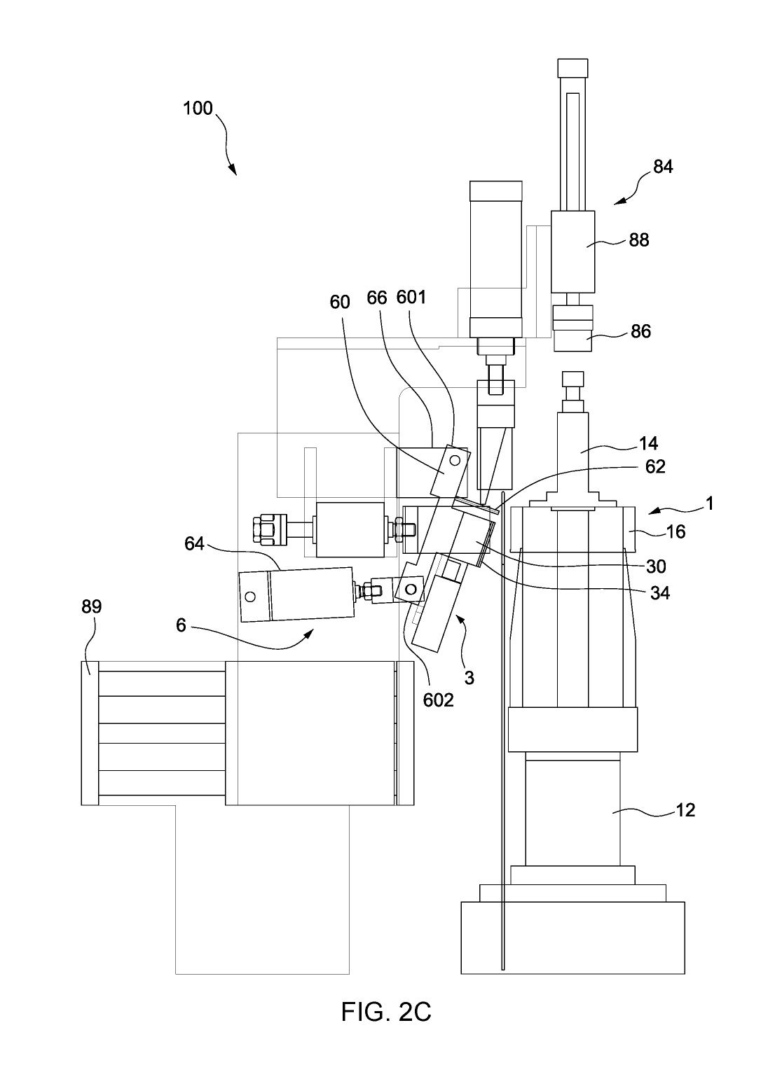

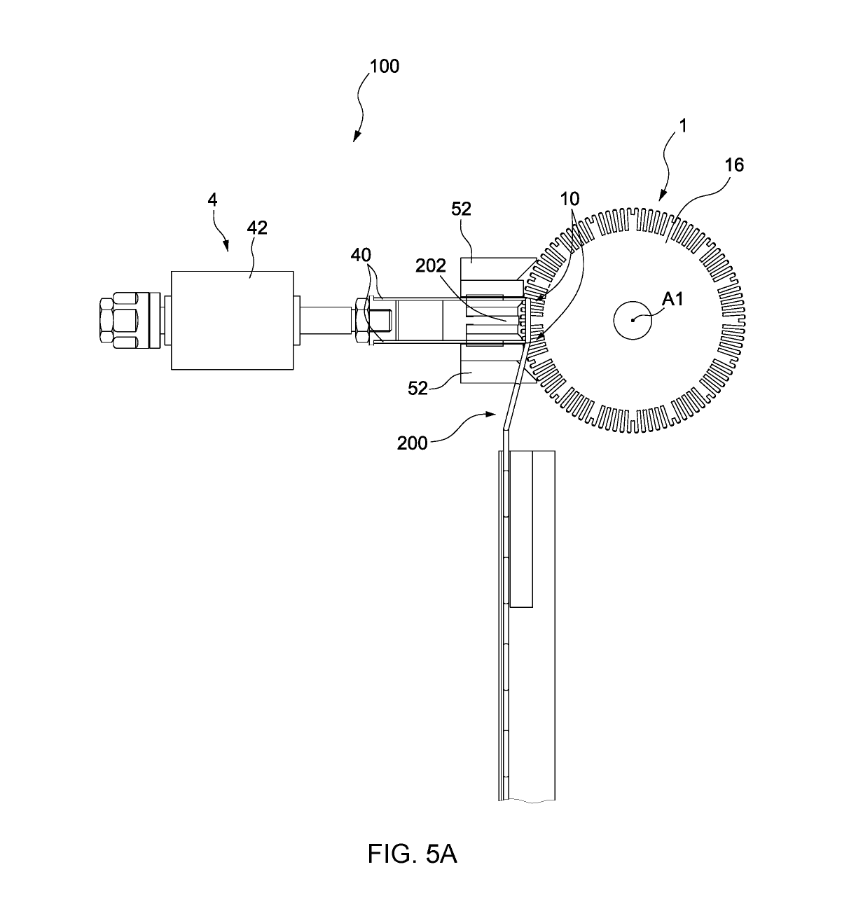

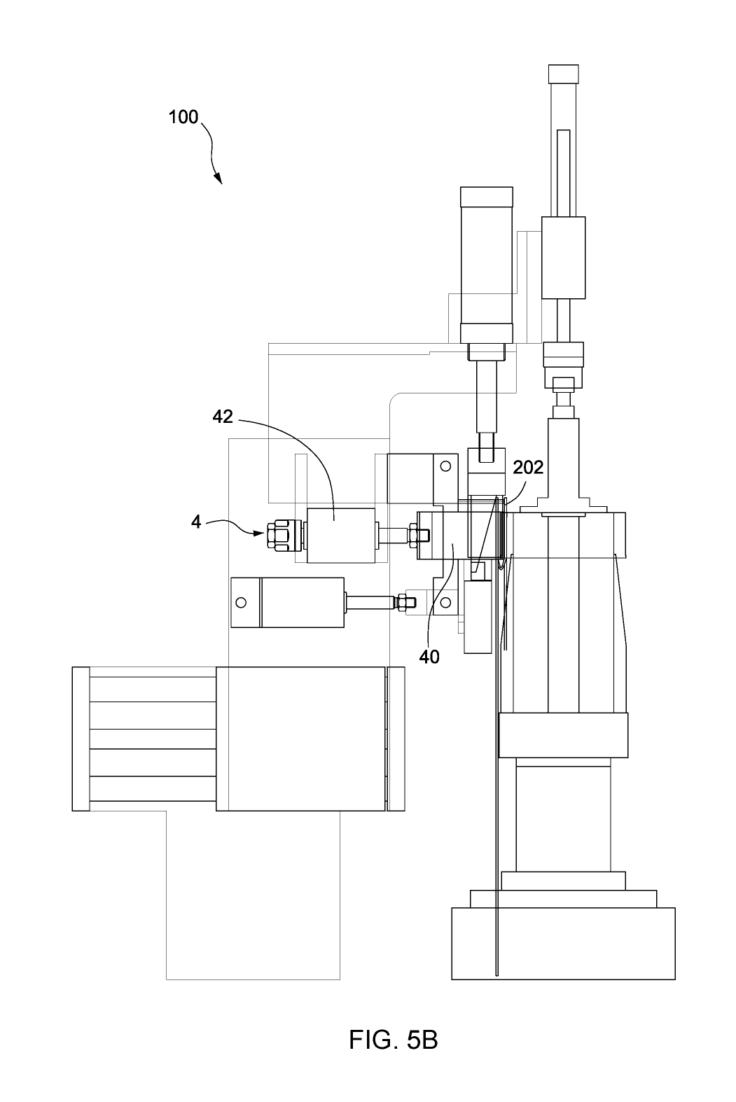

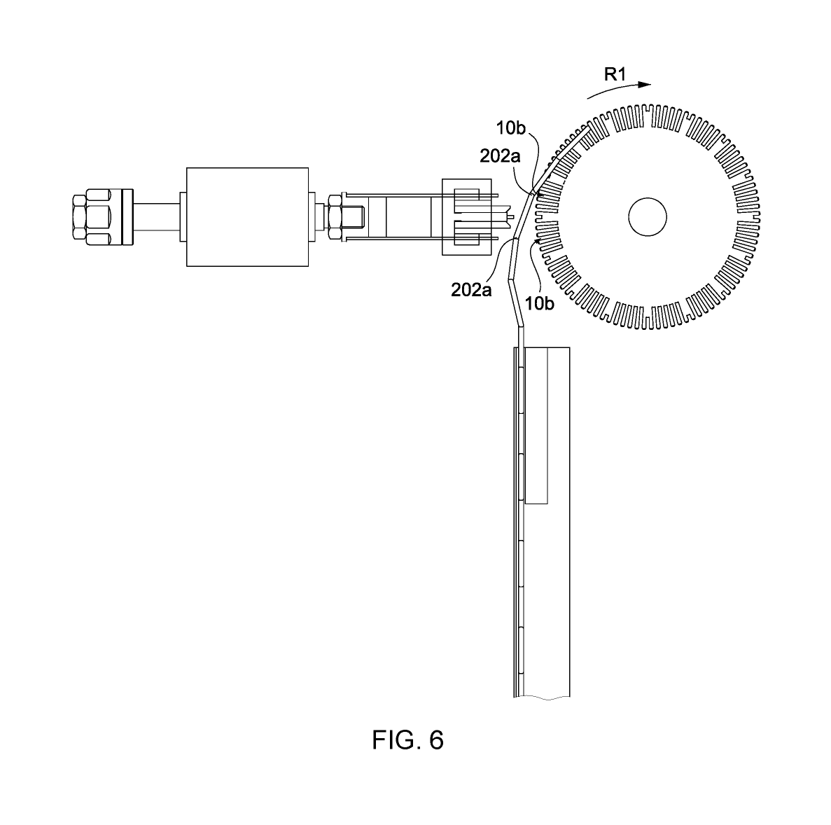

Please refer to FIG. 2A. The rotating receiver 1 is configured to rotate around an axis A1 and receive the wire 200. Referring FIG. 2A and 2C, the rotating receiver 1 includes multiple slots 10 circumferentially disposed thereon and extending along the axis A1. In this embodiment, the rotating receiver 1 includes a rotating actuator 12, a cylinder 14 and a disk 16 (see FIGS. 2A and 2C). The rotating actuator 12 is connected to the cylinder 14 and configured to drive the cylinder 14 to rotate around the axis A1. The cylinder 14 passes through a through hole 18 in the disk 16 and creates an interference fit with and thereby support the disk 16. The disk 16 has the multiple slots 10 circumferentially disposed on the outer surface thereof. In the event that a linear segment 202 of the wire 200 is inserted into any given slot, the wire 200 is being rotated around the axis A1 resulted from the rotation of the rotating receiver 1, as best shown in FIGS. 5A and 6.

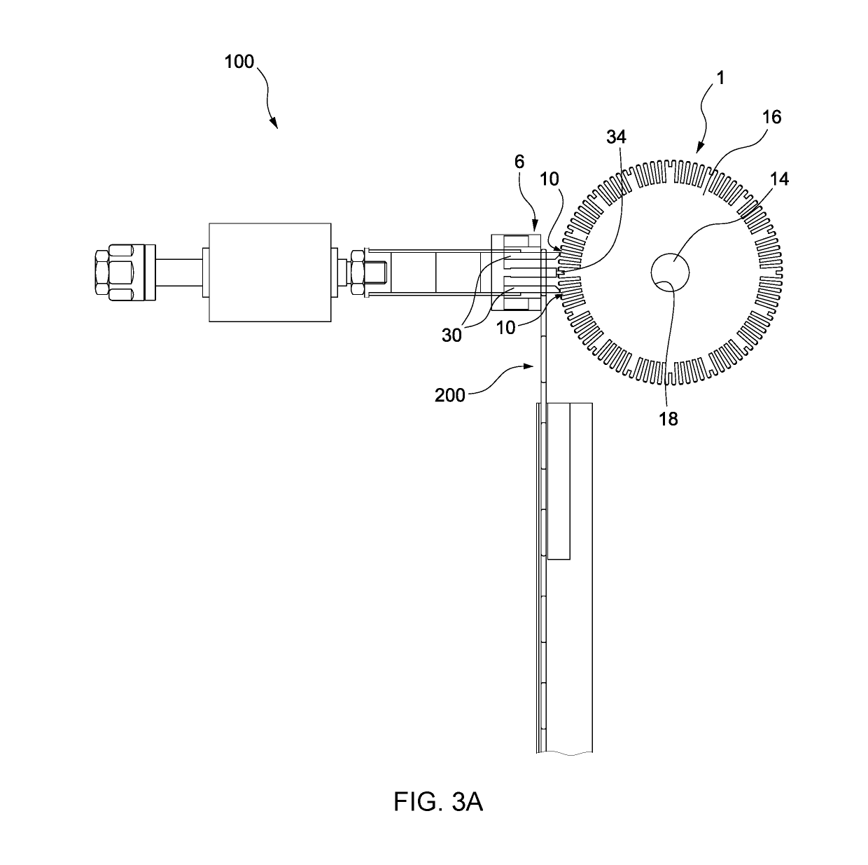

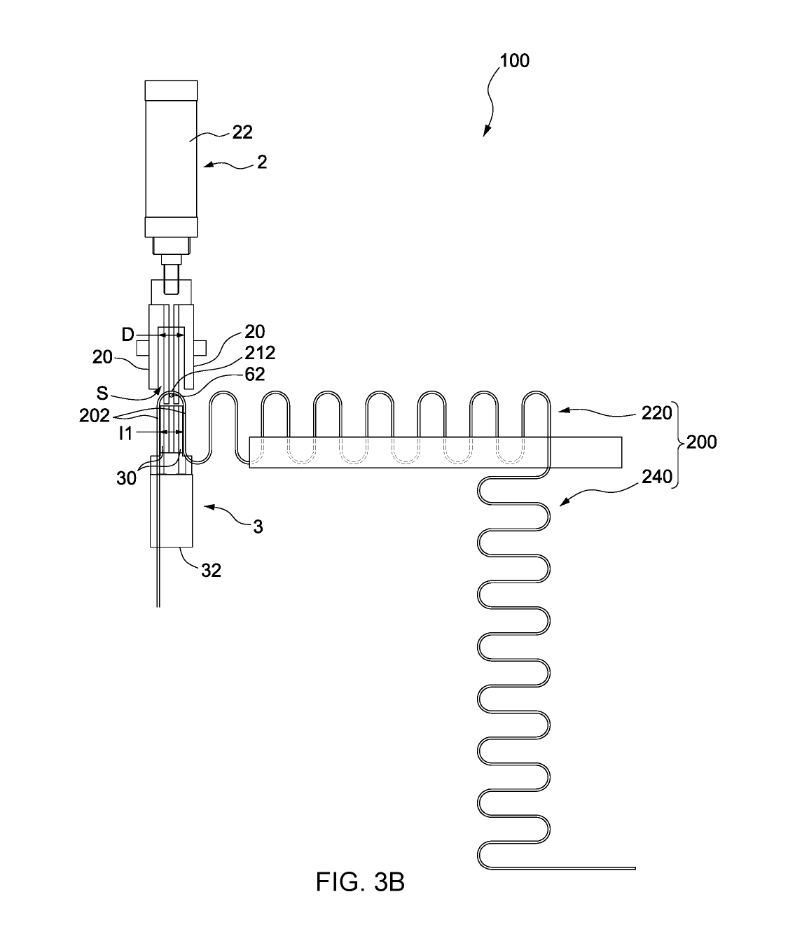

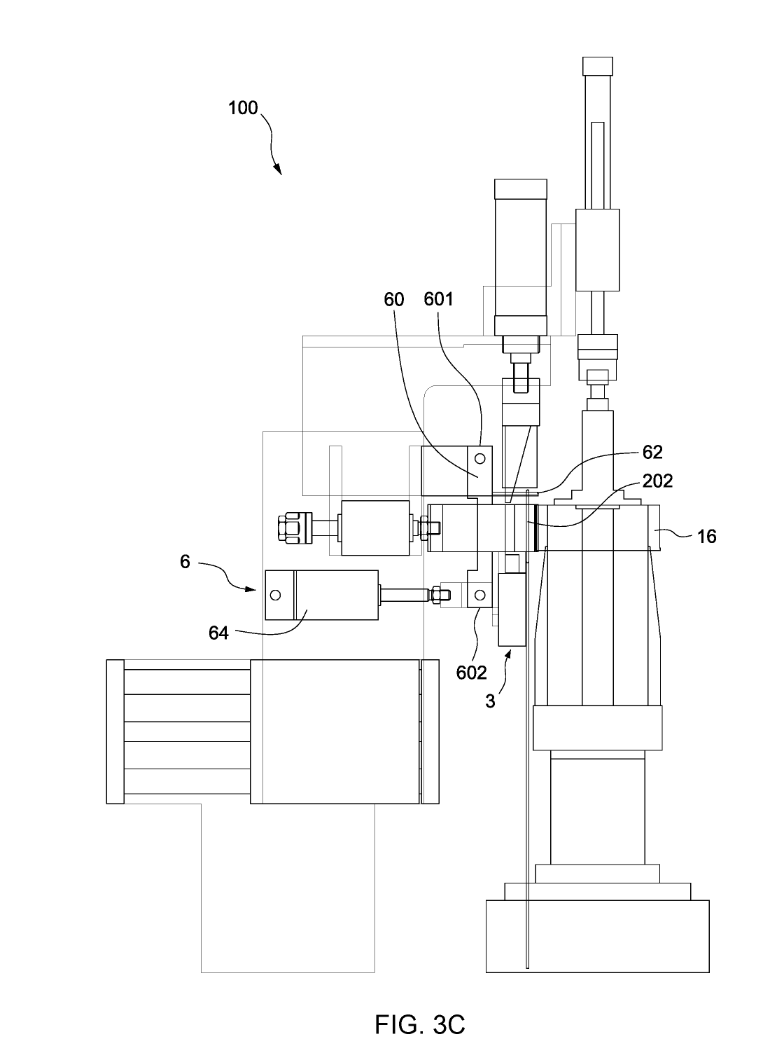

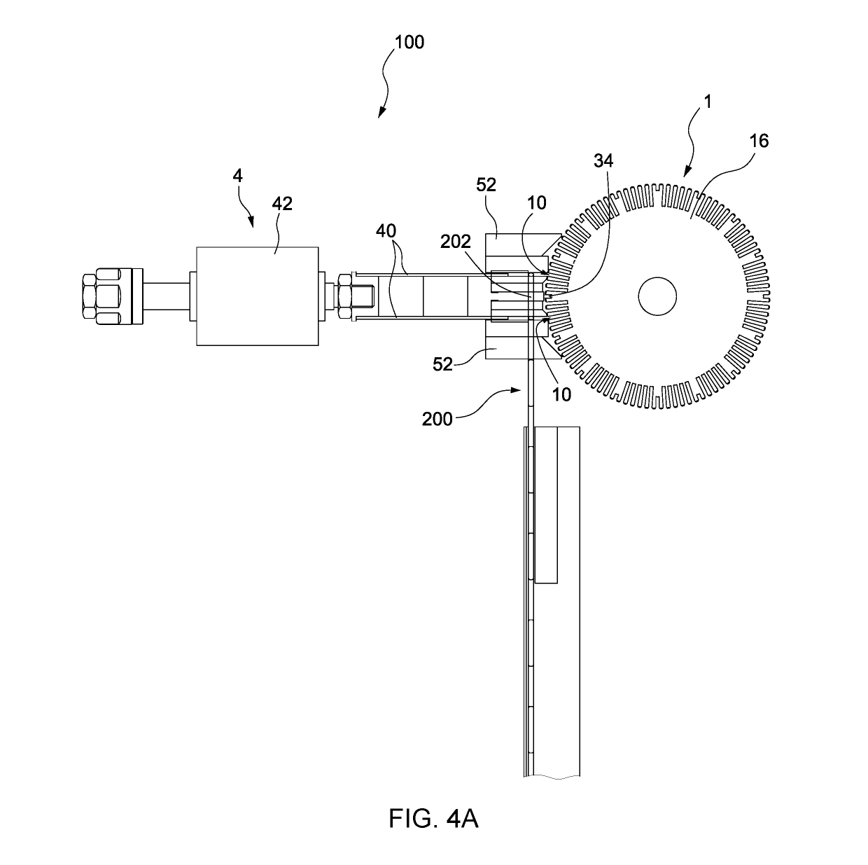

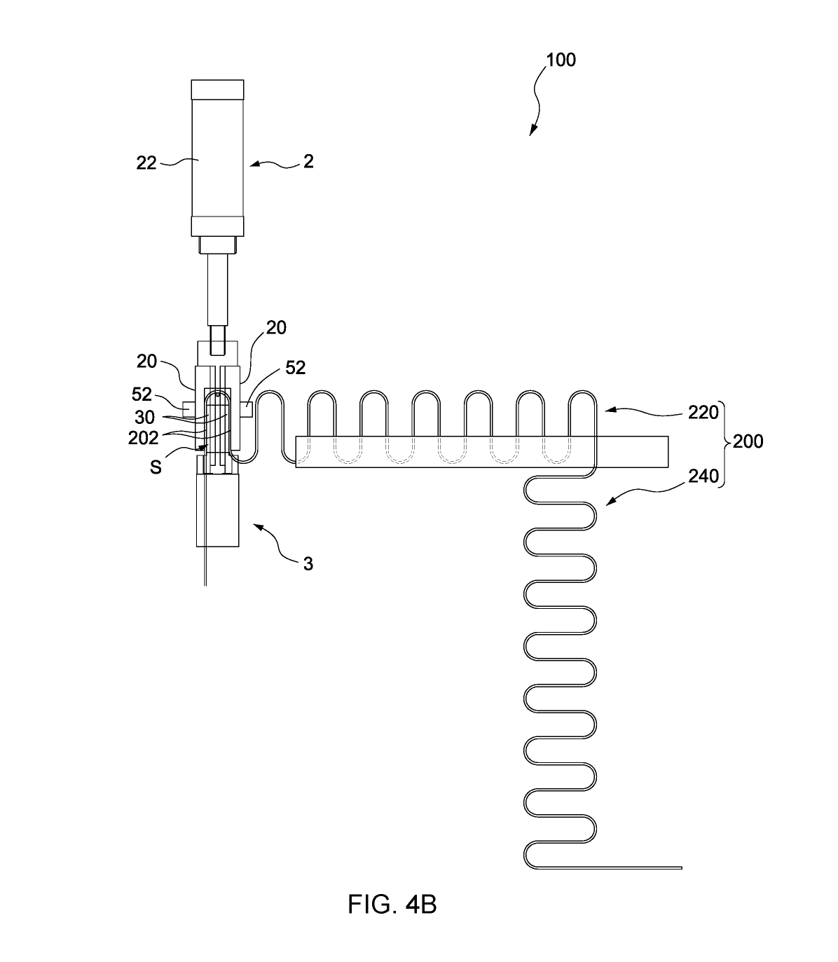

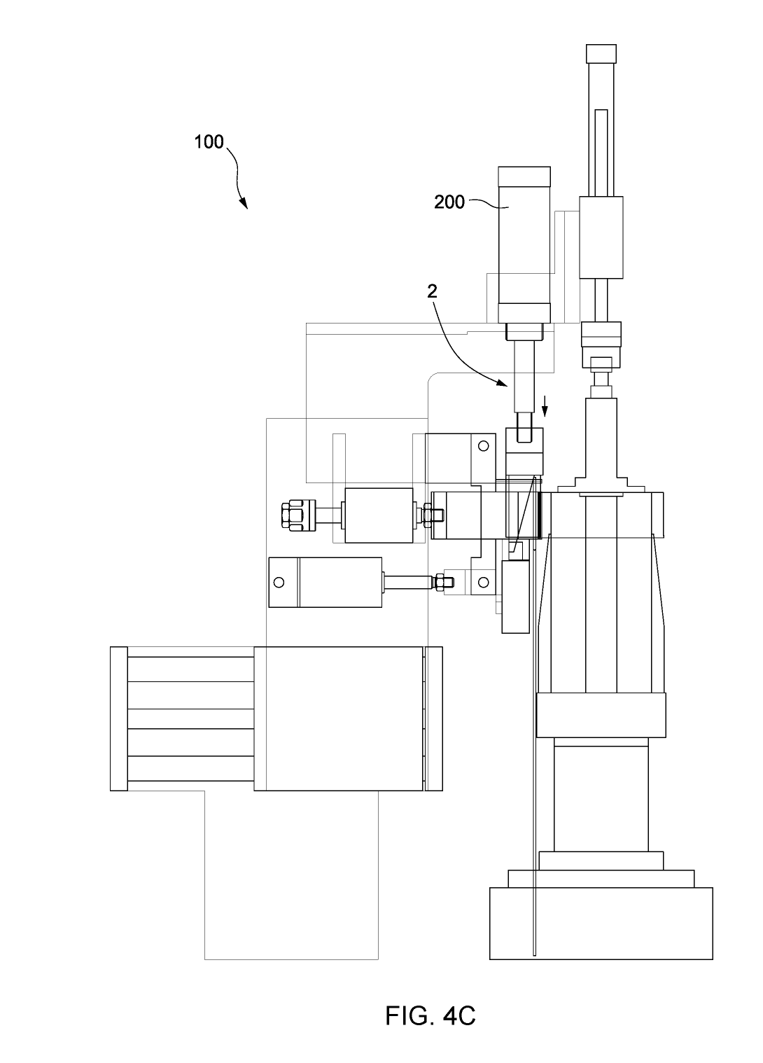

Referring FIGS. 3B and 4B, the confining component 2 is configured to confine two adjacent linear segments 202 of the wire 200 separate within a space S defined by the confining component 2. In this embodiment, two adjacent linear segments 202 are confined within the space S. In other embodiments, one or more than two linear segments 202 may be confined with the space S. In this embodiment, the confining component 2 includes two walls 20 and a first actuator 22. The two walls 20 are separated from each other by a fixed distance D1. The first actuator 22 is configured to move the two walls 20 downwardly to confine the two linear segments 202 within the space S defined by the two walls 20. The two walls 20 retreat to their original positions once the two linear segments 202 have been properly inserted into the slots 10 of the disk 16.

As shown in FIGS. 2B and 3B, the expanding component 3 is configured to adjust the two adjacent linear segments 202 so that the two adjacent linear segments 202 are separated from each other by at least a predetermined interval I1 inside the space S. In some embodiments, the expanding component 3 includes two expanding plates 30 and a second actuator 32. The two expanding plates 30 are generally parallel to each other. The second actuator 32 is configured to laterally move the two expanding plates 30 in an opposite direction to adjust, i.e., expand, the distance between the two adjacent linear segments 202. To ensure that the expanding component 3 would act on the two adjacent linear segments 202, the original interval between the two adjacent linear segments 202 must be arranged to be no greater than the predetermined interval I1.

As shown in FIGS. 2A and 3A, the expanding component 3 further includes a pin 34 disposed between the two confining plates 30 and configured to be detachably inserted into a slot 10a between the two slots 10 to be inserted by the wire 200.

As shown in FIG. 4B, each of the two linear segments 202 may be held between one of the two walls 20 and one of the two expanding plates 30, when the confining component 2 and the expanding component 3 are actuated. That is, by the actuations of both of the confining component 2 and the expanding component 3, the two adjacent linear segments 202 are held to be separate from each other at a desired distance.

As shown in FIGS. 4A and 5A, in this embodiment, the pressing component 4 is configured to press the two linear segments 202 of the wire 200 into two of the slots 10 of the disk 16. In this embodiment, the two slots 10 are not adjacent to each other and other slots 10 are sandwiched between the two slots 10. Furthermore, the pressing component 4 includes two pressers 40 and a pressing actuator 42. The pressing actuator 42 is coupled to the two pressers 40. Each of the pressers 40 may be a thin plate that is substantially as wide as each linear segment 202. In the event that the pressing actuator 42 is actuated, the pressing actuator 42 presses the two pressers 40 towards the two linear segments 202 positioned between one of the two walls 20 of the confining component 2 and one of the two expanding plates 30 of the expanding component 3 towards the two slots 10.

As shown in FIGS. 4A and 4B, in this embodiment, the system 100 further includes two blocks 52. The blocks 52 are disposed on two sides of the confining component 2 and extending towards the rotating receiver 1, respectively. The blocks 52 may be wedge-shaped and are configured to cover the space between the confining component 2 and the rotating receiver 1. When the confining component 2 is moved downwardly to align with the expanding component 3 and the pressing component 4, the two blocks 52 separate the two linear segments 202 to be inserted from other segments of the wire 200. Thus, other parts of the wire 200 are prevented from entering into the space S between the pressing component 4 and the slots 10 to be inserted. Under this arrangement, said other parts of the wire 200 would not to interfere with the pressing process performed by the pressing component 4.

As shown in FIGS. 2C, 3B and 3C, in this embodiment, the system 100 further includes an adjusting component 6 configured to adjusting the height of the two linear segments 202 to a predetermined height corresponding to the height of the two slots 10. In this embodiment, the adjusting component 6 includes a pivoting portion 60, an adjusting rod 62 and a third actuator 64. The pivoting portion 60 has a first end 601 and a second end 602 that are opposite to each other. The first end 601 is pivotally connected to a support 66. The adjusting rod 62 is disposed on the pivoting portion 60. The third actuator 64 is connected to the second end 602 and configured to drive the pivoting portion 60 to pivot about the first end 601 so that the adjusting rod 62 raises a curved segment 212 of the wire 200 that connects the two adjacent linear segments 202.

In this embodiment, the expanding component 3 is provided on the pivoting portion 60 of the adjusting component 6. Thus, when the pivoting portion 60 is driven to pivot, the expanding component 3 is pivoted accordingly. In other embodiments, the expanding component 3 is not disposed on the adjusting component 6 so that when the adjusting component 6 pivots, the expanding component 3 does not pivot accordingly.

As shown in FIG. 2B, in this embodiment, the wire 200 is defined as a first portion 220 and a second portion 240. The first portion 220 and the second portion 240 extend in two different directions, respectively. In this embodiment, the two directions are generally perpendicular to each other. The first portion 220 is inserted into a portion of the slots 10 when the rotating receiver 1 rotates in a first rotating direction. The second portion 240 is inserted into the same or other portion of slots 10 when the rotating receiver 1 rotates in a second rotating direction. In this embodiment, the first rotating direction is opposite to the second rotating direction. For example, the first rotating direction is clockwise from the view of FIG. 1A, and the second rotating direction is counter-clockwise from the view of FIG. 1A.

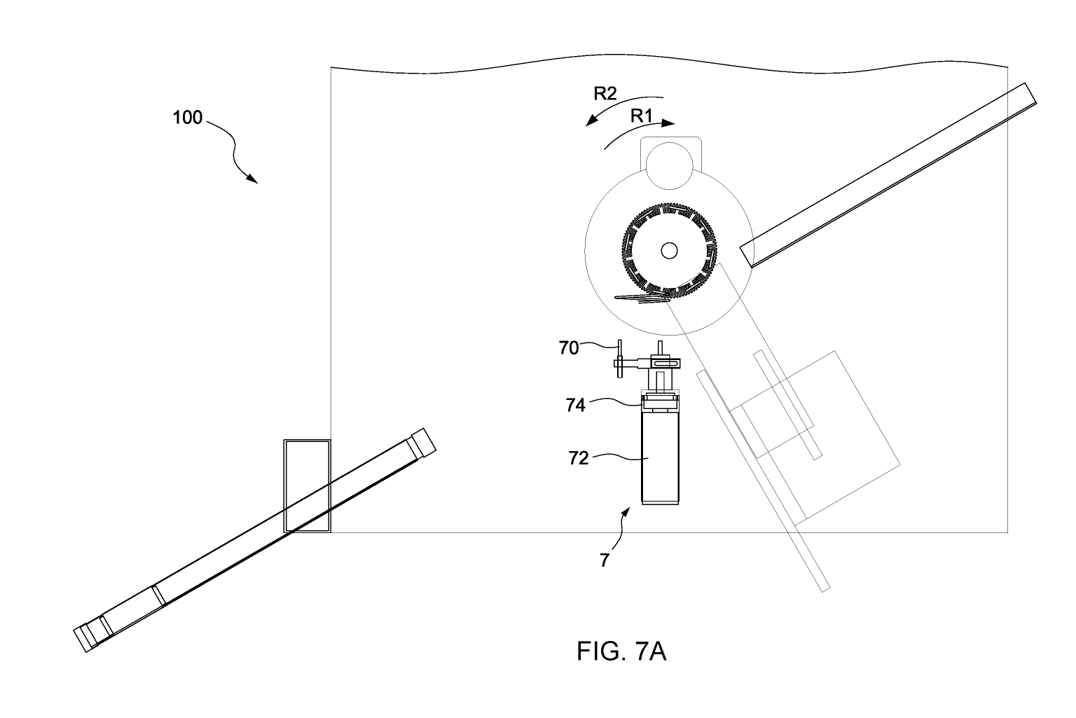

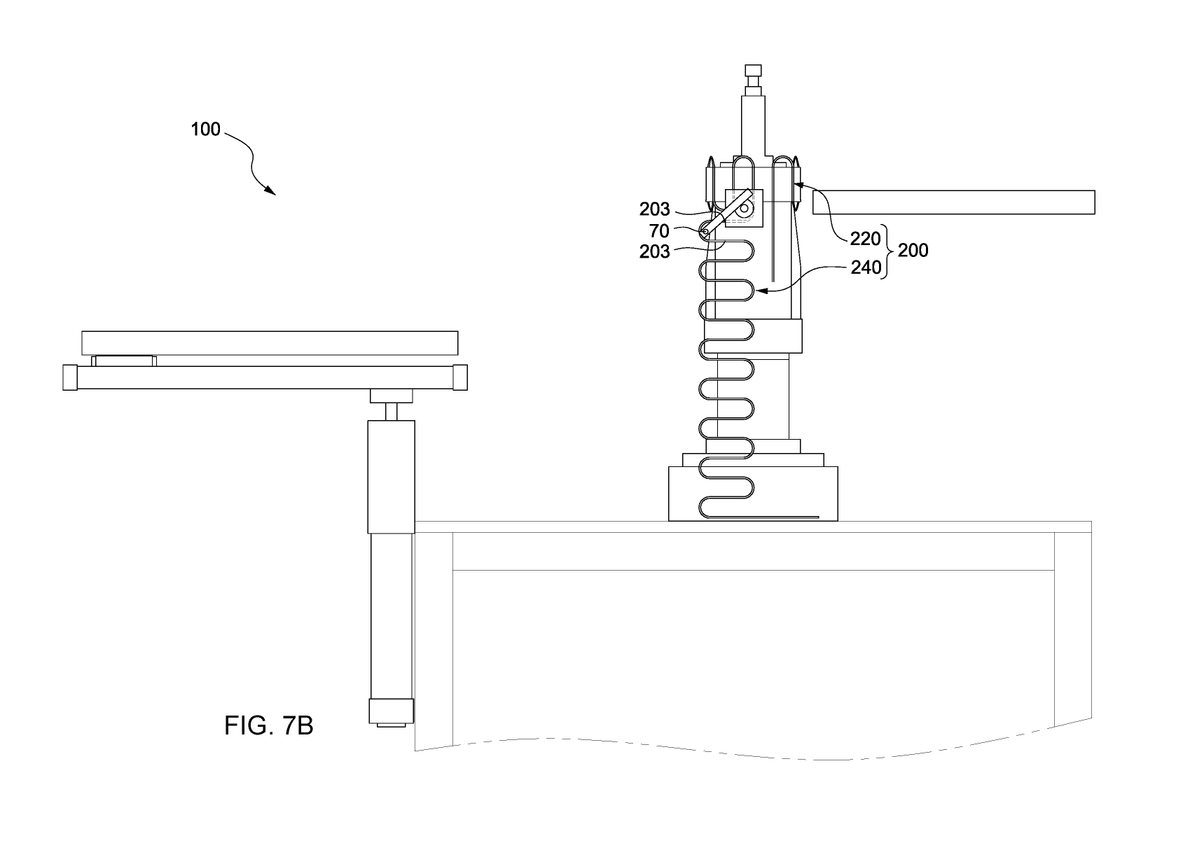

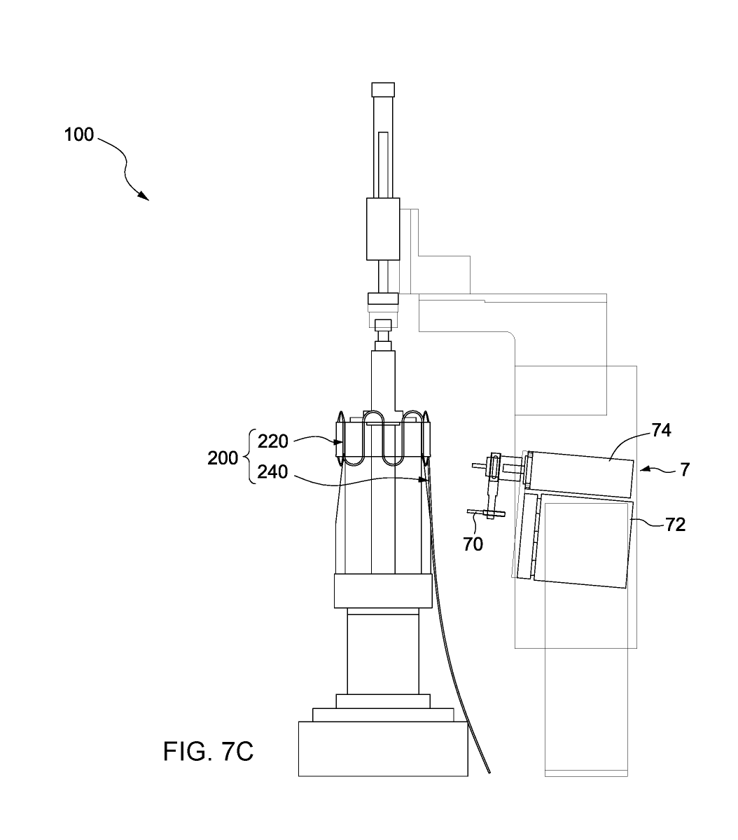

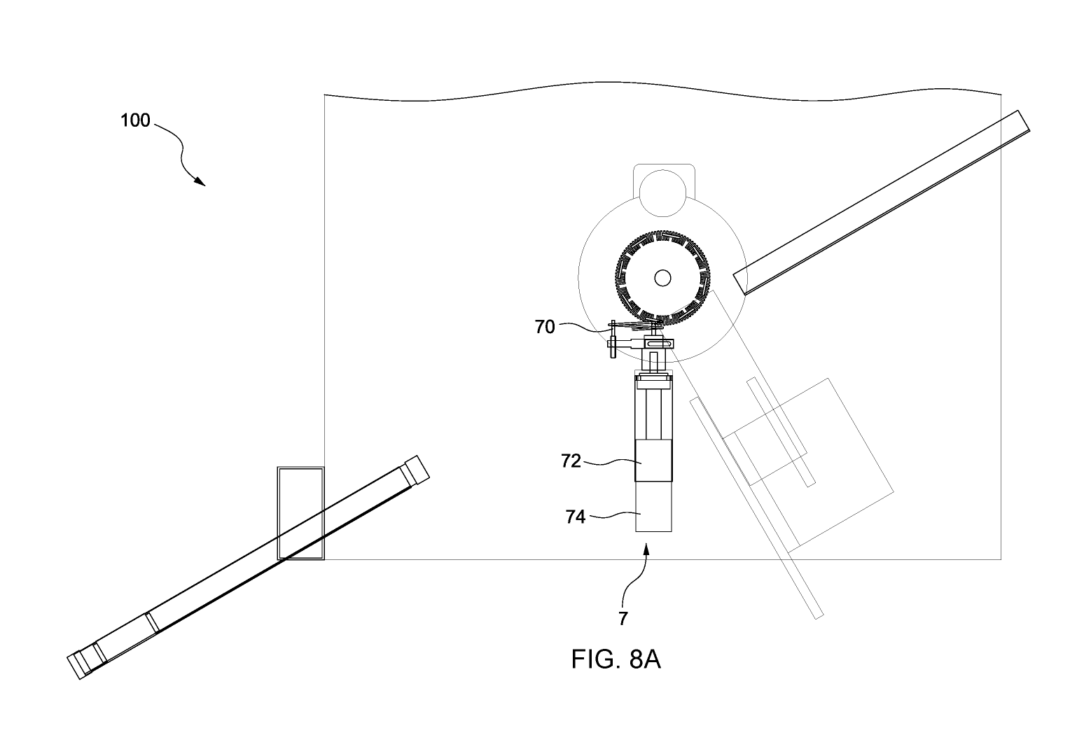

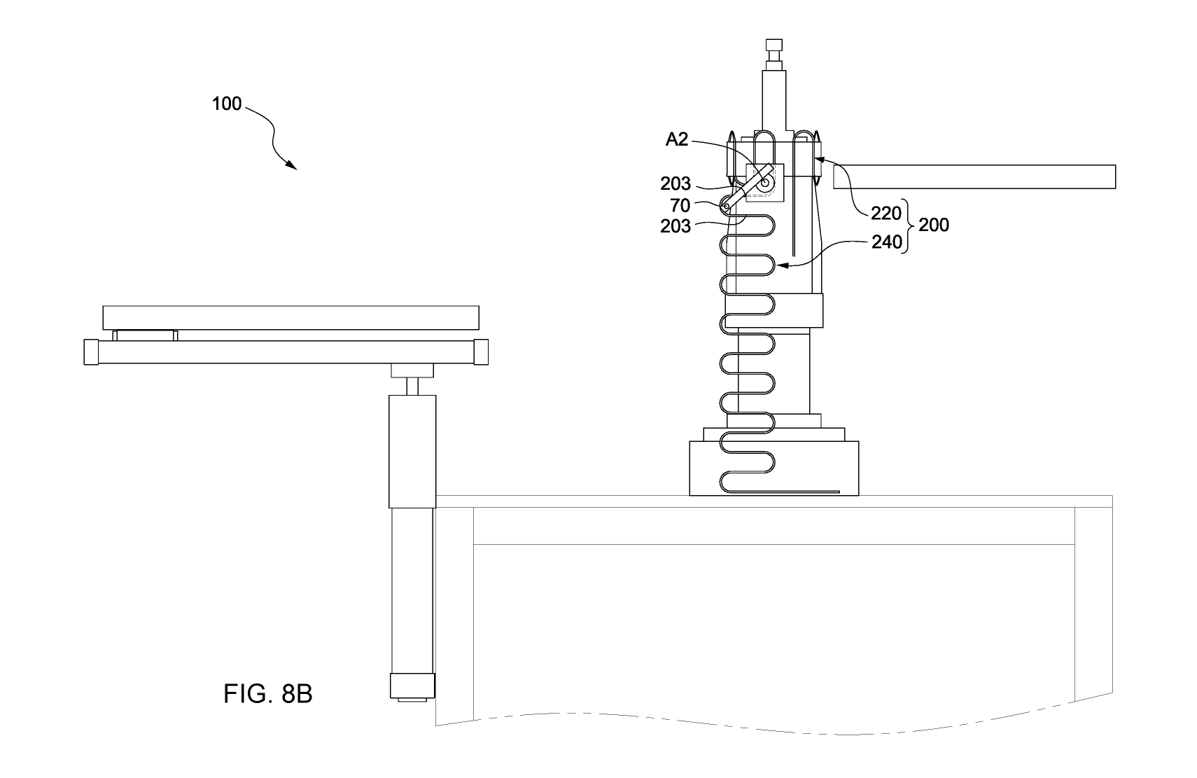

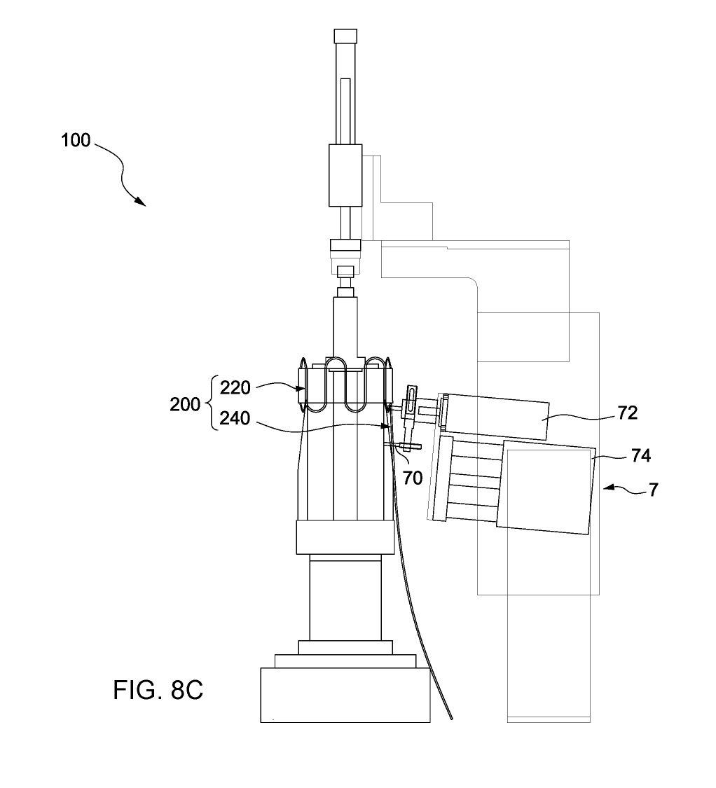

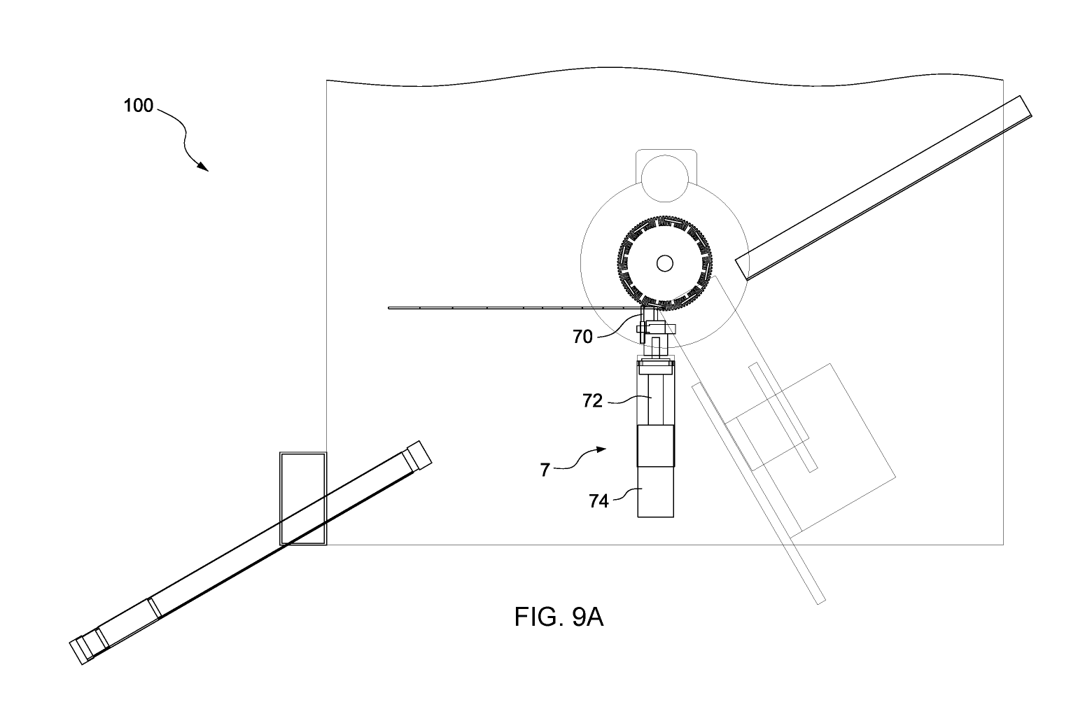

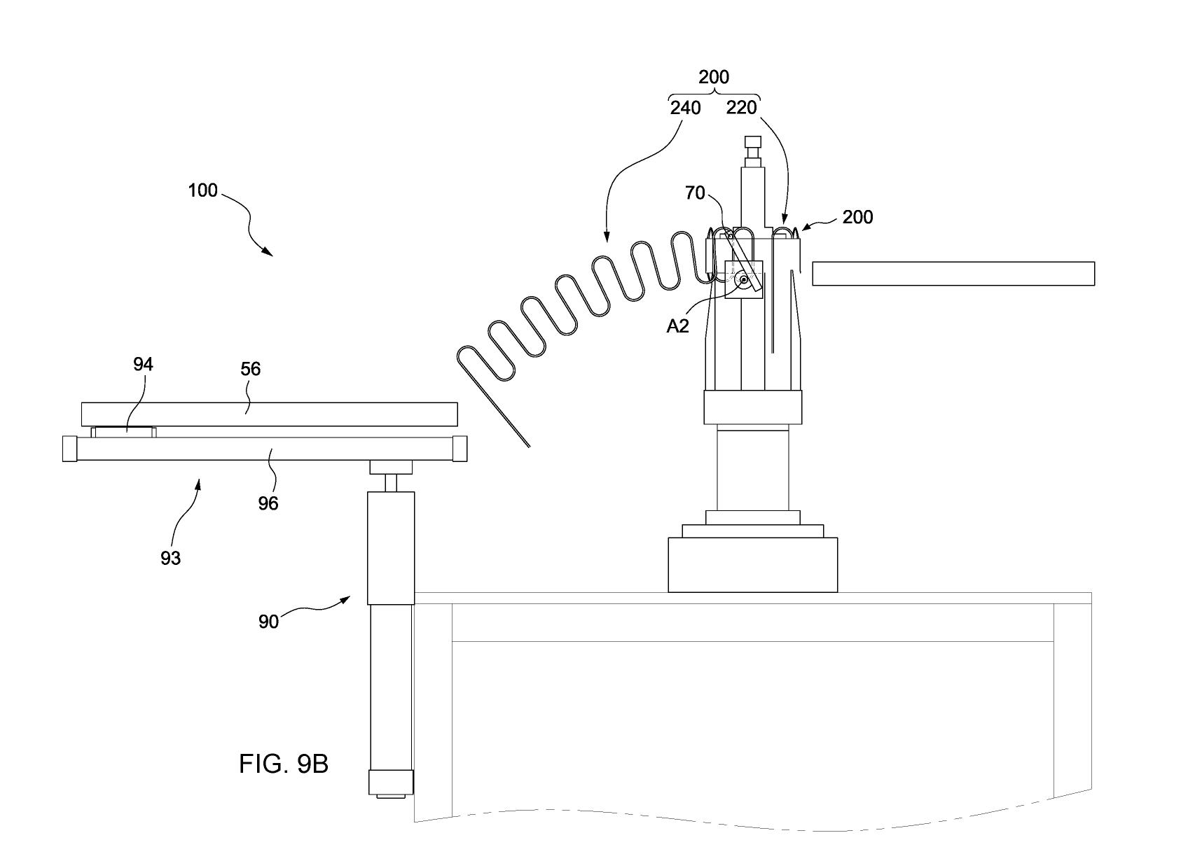

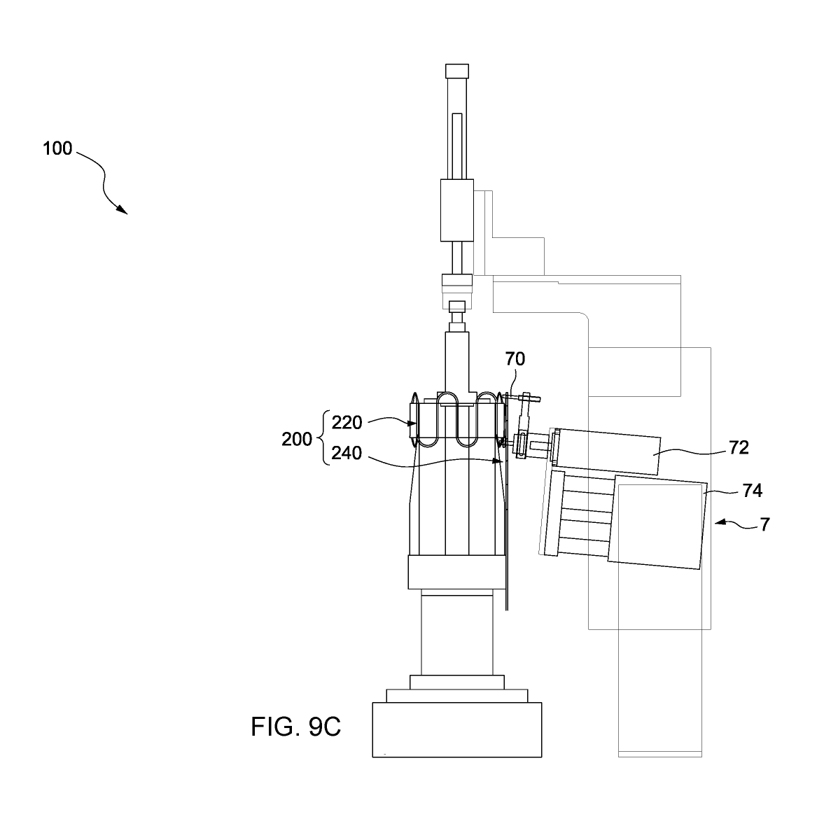

As shown in FIGS. 7C, 8C and 9C, the system 100 may further include a rotating component 7 for rotating the second portion 240 of the wire 200 so that the second portion 240 of the wire 200 is aligned with the first portion 220 of the wire 200. In particular, the rotating component 7 includes a rotating rod 70, a rotating actuator 72 and a linear actuator 74. The linear actuator 74 is configured to drive the rotating rod 70 to move towards or away from the rotating receiver 1. The rotating actuator 72 is configured to move circularly about an axis A2, as best shown in FIGS. 8B and 9B, such that the rotating rod 70 may rotate the second portion 240 to align with the first portion 220 when the linear segments 202 of the first portion 220 have been inserted into the slots 10 of the disk 16 and those of the second portion 240 are ready to be inserted into the slots 10 of the disk 16 in an opposite rotation direction.

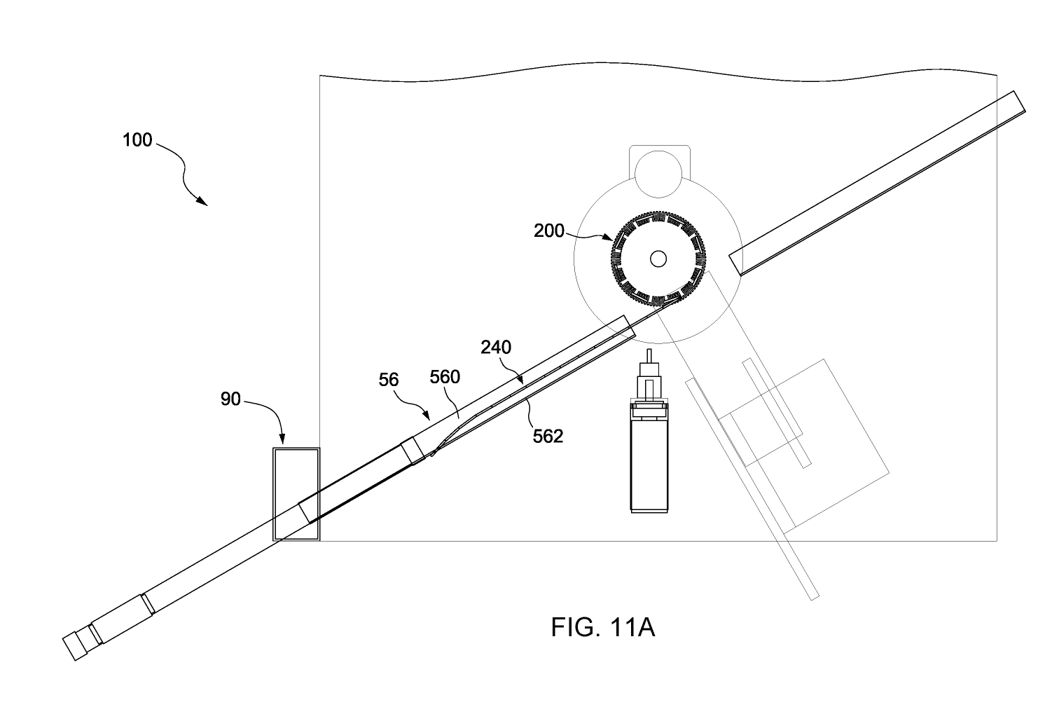

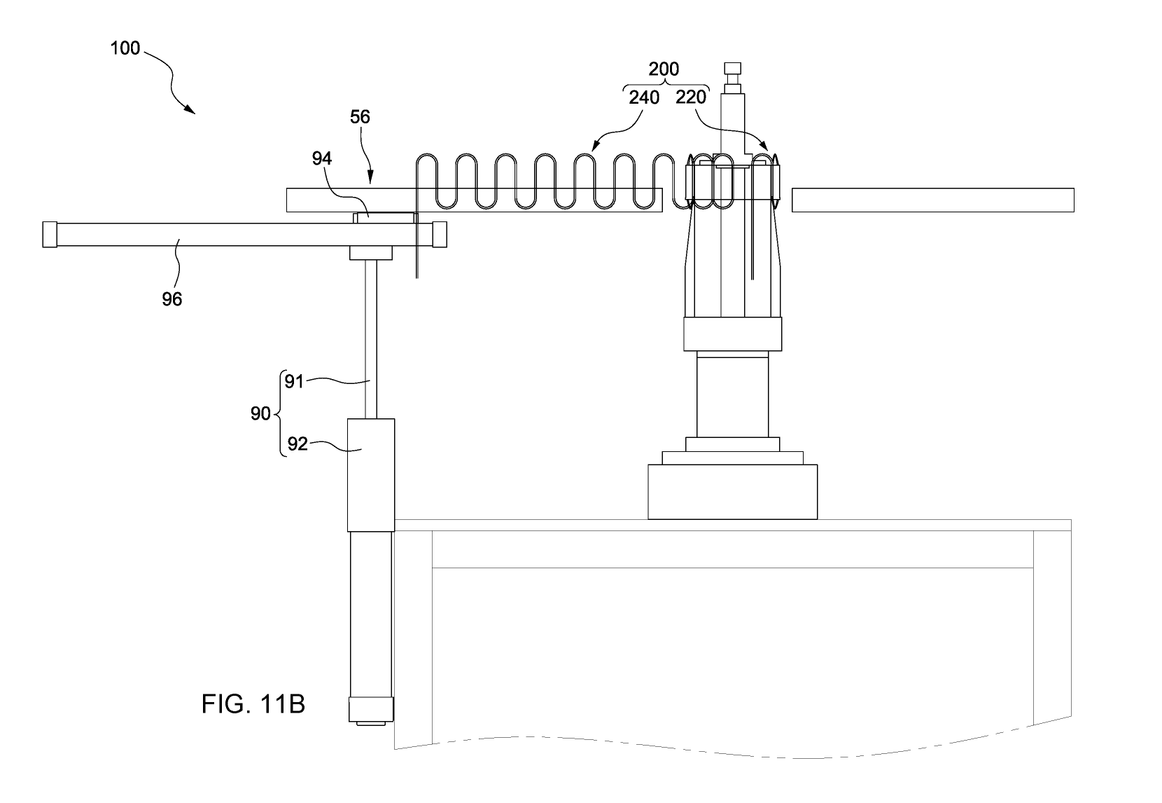

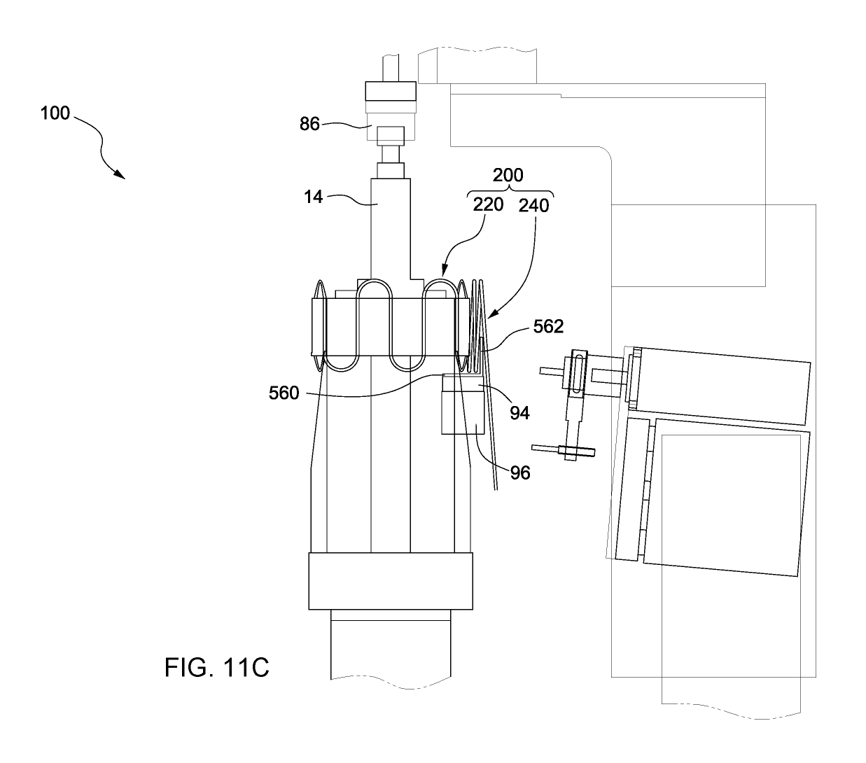

As shown in FIGS. 1A and 1B, the system 100 further includes a first rail 54 and a second rail 56. The first rail 54 is configured to bear the first portion 220 of the wire 200. The second rail 56 is configured to bear the second portion 240 of the wire 200. The first rail 54 and the second rail 56 are disposed near two opposing sides of the rotating receiver 1, respectively. In particular, the first rail 54 may include a bottom plate 540, a standing plate 542 and a guiding plate 544. The bottom plate 540 extends towards the side of the rotating receiver 1. The standing plate 542 is disposed on an edge of the bottom plate 540 and extends upwardly. The guiding plate 544 is disposed on the edge of the bottom plate 540 that is close to the rotating receiver 1. The first portion 220 of the wire 200 may lean against and be guided by the standing plate 542 and the guiding plate 544 and be moveable along the bottom plate 540. Similarly, as shown in FIGS. 11A and 11B, the second rail 56 includes a bottom plate 560 and a standing plate 562. The bottom plate 560 extends towards the side of the rotating receiver 1. The standing plate 562 is disposed on an edge of the bottom plate 560 and extends upwardly. The second portion 240 may lean against the standing plate 562 and be moveable along the bottom plate 560.

In this embodiment, as shown in FIG. 1A, the system 100 further includes a pushing component 8 configured to push the wire 200 on the first rail 54 towards the rotating receiver 1. The pushing component 8 includes a pushing rod 80 and a pushing actuator 82 coupled to the pushing rod 80. The pushing actuator 82 is configured to push the pushing rod 80 to move along the first rail 54 so that the first portion 220 of the wire 200 is moved towards the rotating receiver 1 along the first rail 54.

As shown in FIG. 1B, in this embodiment, the system 100 further includes a lifting component 90 for lifting the second rail 56. The lifting component 90 is configured to move upward or downward. The lifting component 90 includes a lifting rod 91 and a lifting actuator 92. One end of the lifting rod 91 is coupled to the bottom of the second rail 56, and the other end of the lifting rod 91 is coupled to the lifting actuator 92. The lifting actuator 92 is configured to move the lifting rod 91 upward so that the second rail 56 is lifted accordingly. The lifting rod 91 may be retreated to its original position once the lifting process is completed.

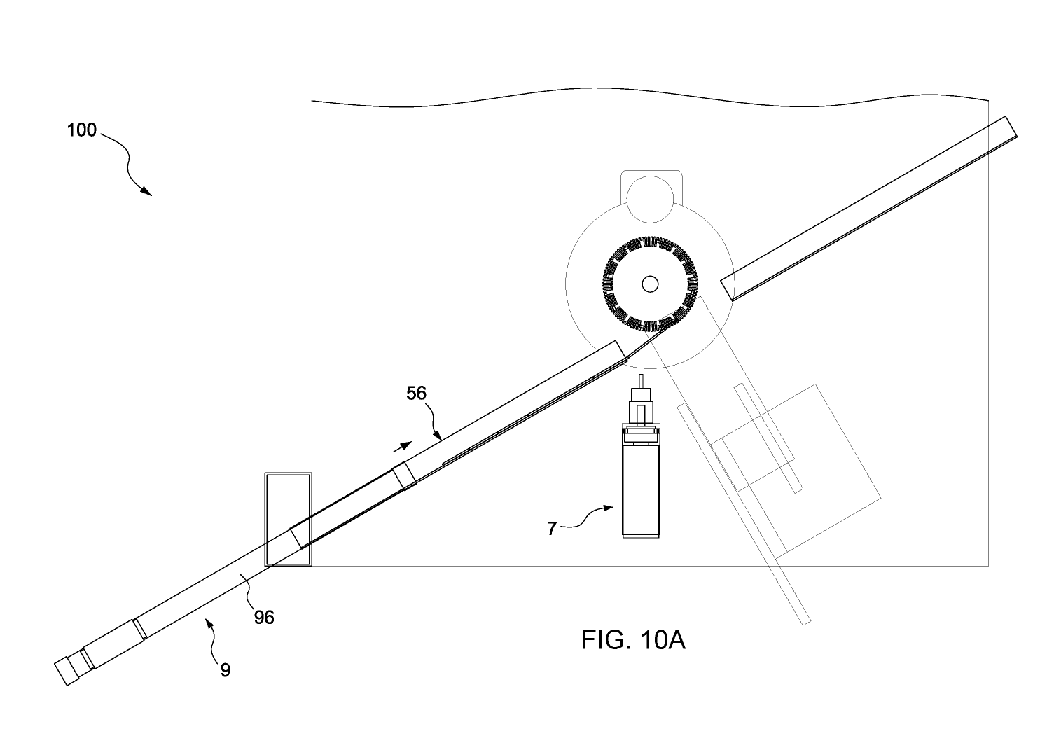

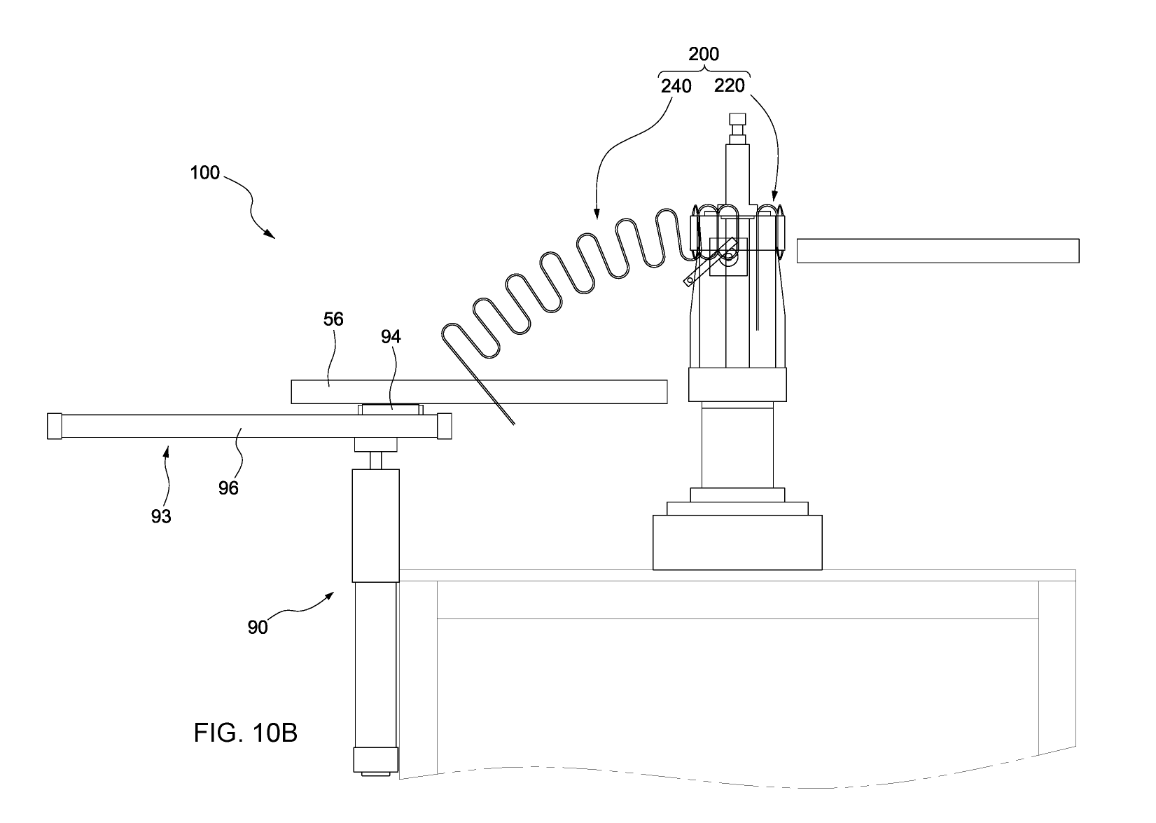

As shown in FIGS. 9B and 10B, in this embodiment, the system 100 further includes a moving component 93 for moving the second rail 56 towards or away from the rotating receiver 1. The moving component 93 is disposed on the lifting component 90. Furthermore, the moving component 93 includes a moving cart 94, a third rail 96 and a moving actuator (not shown). The moving cart 94 is moveably disposed on the third rail 96 and configured to bear the second rail 56. The moving actuator is configured to drive the moving cart 94 to move along the third rail 96 so that the second rail 56 is moved along the second rail 56.

As shown in FIGS. 1C and 2C, in this embodiment, the system 100 further includes a holding component 84 for detachably holding a free end of the cylinder 14 of the rotating receiver 1 and a horizontal actuator 89. The holding component 84 includes a holder 86 and a vertical actuator 88. The vertical actuator 88 is configured to drive the holder 86 to move vertically so that the holder 86 may securely hold or release the cylinder 14. The horizontal actuator 89 is configured to drive the confining component 2, the expanding component 3, the pressing component 4 and the adjusting component 6 to move towards or away from the rotating receiver 1. In the event that the holder 86 is released from the cylinder 14, the horizontal actuator 89 is configured to drive the holder 84 to move horizontally so that the holder 84 is moved away from the rotating receiver 1, i.e., the holder is not right above the cylinder 14.

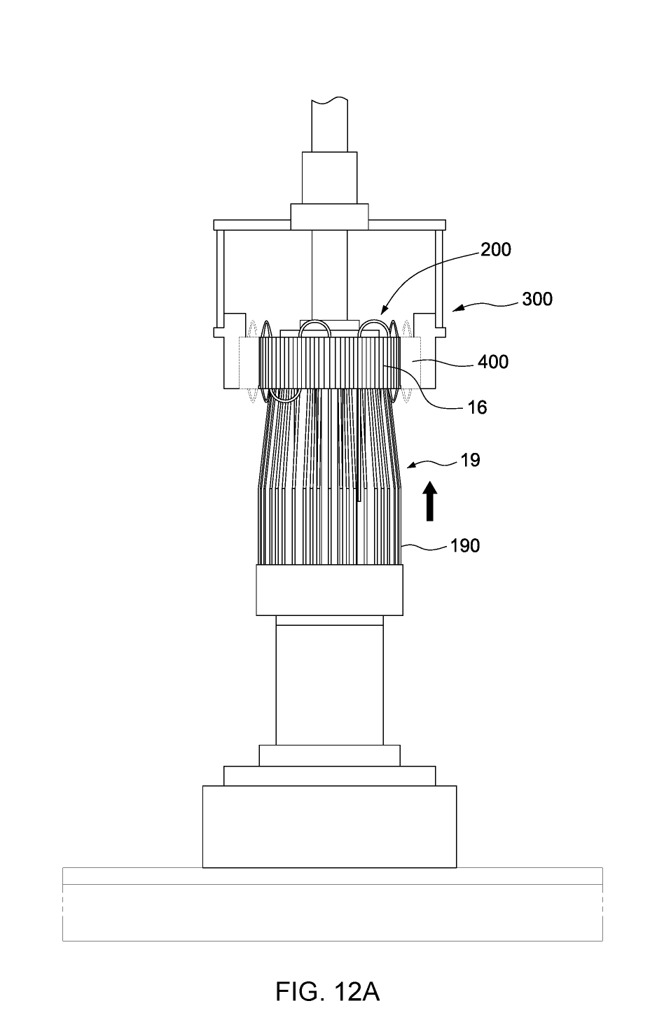

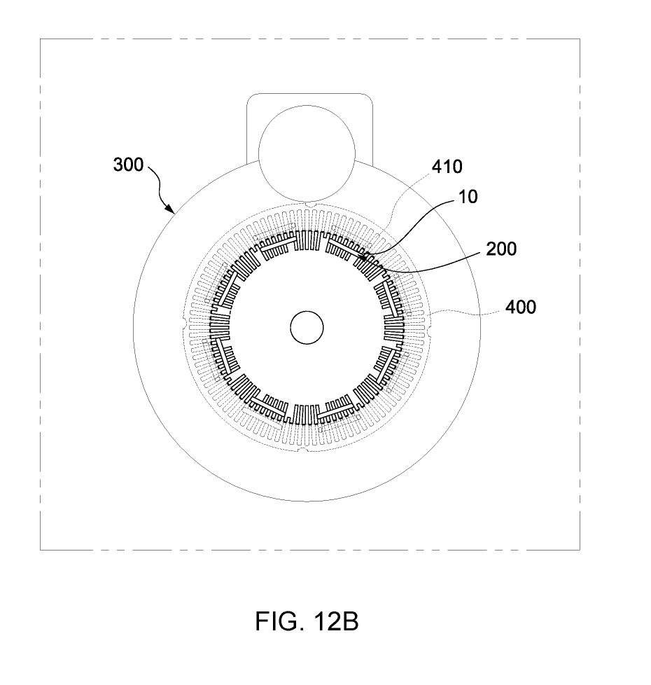

As shown in FIGS. 12A and 12B, in this embodiment, the system 100 further includes a lid 300 detachably disposed on a free end the cylinder 14 for housing a stator core 400 corresponding to the disk 16. In addition, the rotating receiver 1 further includes an extruding mechanism 19. The extruding mechanism 19 has an extruding actuator 190 and extruding components 190 that are movable along the slots 10 driven by the extruding actuator 190 to extrude the wire 200 from the slots 10 of the disk 16 into the corresponding slots 410 of the stator 400 after the wire 200 is completely inserted into the corresponding slots 10 of the disk 16.

An embodiment of the present disclosure provides a method for inserting a wire 200 having a wavy shape into a stator core 400 using the system 100 described above. The method includes the steps of providing a wire 200 on a first rail 54 next to a side of a rotating receiver 1, as shown in FIGS. 1A-1C. In this embodiment, only a first portion 220 of the wire 200 is disposed on the first rail 54 and a second portion 240 of the wire 200 that is substantially perpendicular to the first portion 220 is hung below the first rail 54. Next, as shown in FIGS. 2A-2C, the wire 200 is moved to the side of the rotating receiver 1 having multiple slots 10 so that two adjacent linear segments 202 of the wire 200 correspond to two of the slots 10. At this time, an end of the wire 200 is disposed between the pressing component 4 and the disk 16 of the rotating receiver 1. In addition, a pushing component 8 next to the side of the first rail 54 is actuated to push the wire 200 to move along the first rail 54. In another embodiment, the wire 200 may be manually pushed towards the rotating receiver 1.

Then, as shown in FIGS. 3A-3C, in this embodiment, the method further includes adjusting the height of the two linear segments 202 to a predetermined height corresponding to the height of the two slots 10 of the disk 16. In this embodiment, an adjusting component 6 is actuated so that an adjusting rod 62 is pivoted by a third actuator 64 to lift a curved segment 212 connecting two adjacent linear segments 202 to the predetermined height. Thus, the heights of the linear segments 202 may precisely correspond to the heights of the slots 10. In this embodiment, as shown in FIGS. 2A and 3A, while the adjusting component 6 is actuated, a pin 34 connected to the adjusting component 6 is detachably inserted into a slot 10a between the two slots 10 of the disk 16 and the two slots 10 are to be inserted by the wire 200. The insertion of the pin 34 may enhance the alignment between expanding component 3 and the rotating receiver 1.

Next, the distance between the two linear segments 202 is adjusted by an expanding component 3 having two expanding plates 30 so that the two linear segments 202 are separated by a predetermined interval. As shown in FIGS. 3A-3B, an expanding component 3 is actuated so that a second actuator 32 drives two parallel expanding plates 30 to move to expand or maintain the distance between the two adjacent linear segments 202. The original distance between the two linear segments 202 is pre-arranged to be less than the distance between the two expanding plates 30 after the expansion process, then the ultimate distance between the two linear segments 202 is accordingly enlarged after the expansion process.

As shown in FIGS. 4A-4C, the two adjacent linear segments 202 of the wire 200 are confined by two walls 20 of a confining component 2 and are to be expanded within a space S defined by the confining component 2. In particular, the two walls 20 of the confining component 2 are separated from each other by a fixed distance. A first actuator 22 is configured to move the two walls 20 downwardly to confine the two linear segments 202 within the space S defined by the two walls 20. Each of the two linear segments 202 is held between one of the two walls 20 and one of the two expanding plates 30, when the confining component 2 and the expanding component 3 are actuated. Hence, by the actuations of both of the confining component 2 and the expanding component 3, the two adjacent linear segments 202 are held to separate from each other at a desired distance. In the meantime, two blocks 52 of a wedge shape are disposed on two opposing sides of the confining component 2 to separate the two linear segments 202 of the wire 200 to be inserted into the slots 10 of the disk 16 from other linear segments 202 of the wire 200.

Then, as shown in FIGS. 5A-5B, the two linear segments 202 are pressed into the two slots 10 of the disk 16 of the rotating receiver 1 by a pressing component 4. In this embodiment, a pressing actuator 42 of the pressing component 4 is actuated to drive two pressers 40 of the pressing component 4 to pass through the gaps between respective one of the two walls 20 and respective one of the two expanding plates 30. Thus, the two linear segments 202 of the wire 200 are pressed by the two pressers 40, respectively, to be inserted into the corresponding two slots 10 of the disk 16 of the rotating receiver 1.

After the two linear segments 202 are inserted into the two slots 10, the adjusting component 6, the confining component 2, the expanding component 3, the pressing component 4 and the holder are returned to their original positions. Then, as shown in FIG. 6, the rotating receiver 1 is rotated in a first rotating direction R1 at a predetermined degree so that another two adjacent linear segments 202a of the wire 200 correspond to other two of the slots 10b. The above steps for linear segments 202 are also applicable to said another two linear segments 202a, which are to be inserted into said other two of the slots 10b. Then, the foregoing steps may be performed until all linear segments 202 of the first portion 220 of the wire 200 are inserted into the designated slots 10.

Next, the rotating receiver 1 is rotated to a predetermined position in the first rotating direction R1 or a second rotating direction R2 so that the second portion 240 of the wire 200 is located adjacent to the pressing component 4, as shown in FIGS. 7A-7C. Then, as shown in FIGS. 8A-8C, a linear actuator 74 of a rotating component 7 is actuated to move a rotating rod 70 of the rotating component 7 to be located between two linear segments 203 of the second portion 240. Then, as shown in FIGS. 9A-9C, a rotating actuator 72 is actuated to rotate the rotating rod 70 about an axis A1 such that the second portion 240 is rotated accordingly to align with the first portion 220. It can be understood from FIGS. 9A-9C that at this stage, only the part of the second portion 240 directly hung by the rotating rod 70 aligns with the first portion 220, and other parts of the second portion 240 hangs down due to the weight thereof as shown in FIG. 9B.

Then, as shown in FIGS. 10A-10B, the rotating component 7 returns to its original position. A moving component 93 is actuated to move a second rail 56 towards the second portion 240 of the wire 200. In particular, a moving actuator is actuated to move a moving cart 94 that bears the second rail 56 to move along a third rail 96. Then, as shown in FIGS. 11A-11C, a lifting component 90 is actuated to lift the second rail 56 such that the entire second portion 240 aligns with the first portion 220. In particular, a lifting actuator 92 of the lifting component 90 is actuated to lift a lifting rod 91 of the lifting component 90 that bears the second rail 56 and the moving component 93. The other part of the second portion 240 that hangs down is now supported by the second rail 56.

The foregoing steps of height adjustment, confinement, expansion and insertion are performed to insert two linear segments 202 of the second portion 240 into two corresponding slots 10 of the disk 16. Then, the rotating receiver 1 is rotated in the second direction opposite to the first direction. Then, the above steps are repeated for several times until all linear segments 202 of the second portion 240 of the wire 200 are inserted into the corresponding slots 10 of the disk 16.

After the wire 200 is inserted into the disk 16, the holder 86 is detached from the cylinder 14. Then, a lid 300, which houses a stator core 400, is moved to surround the disk 16, as shown in FIGS. 12A and 12B and slots 410 of the stator core 400 correspond to the slots 10 of the disk 16, respectively. Then, the wire 200 is extruded from the slots 10 towards slots 410 of the stator core 400 by an extruding mechanism 19 having multiple extruding components 190. The extruding components 190 are movable along the slots 10 of the disk 16 to extrude the wire 200 to the corresponding slots 10 of the stator core 400. In particular, the extruding components 190 are plate shape and the widths thereof are increased from the top to the bottom. The largest width of the extruding component 190 may be greater the depth of the slots 10 and the smallest width may be less than the depth of the slots 10. Thus, when the extruding components 190 enter into the slots 10 along the direction of the slots, since the width of the extruding component 190 is gradually increased, during the above entering process, the wire 200 in the disk 16 (solid lines in FIGS. 12A and 12B) is gradually extruded out from the slot 10 of the disk 16 to the corresponding slot 410 of the stator core 400 as illustrated in broken lines shown in FIGS. 12 A and 12B.

After all the wires 200 are inserted into the stator core 400, the lid 300 engaged with the stator core 400 is detached from the rotating receiver 1. Next, the stator core 400 with the wires 200 may be removed from the lid 300 to form an independent wound stator.

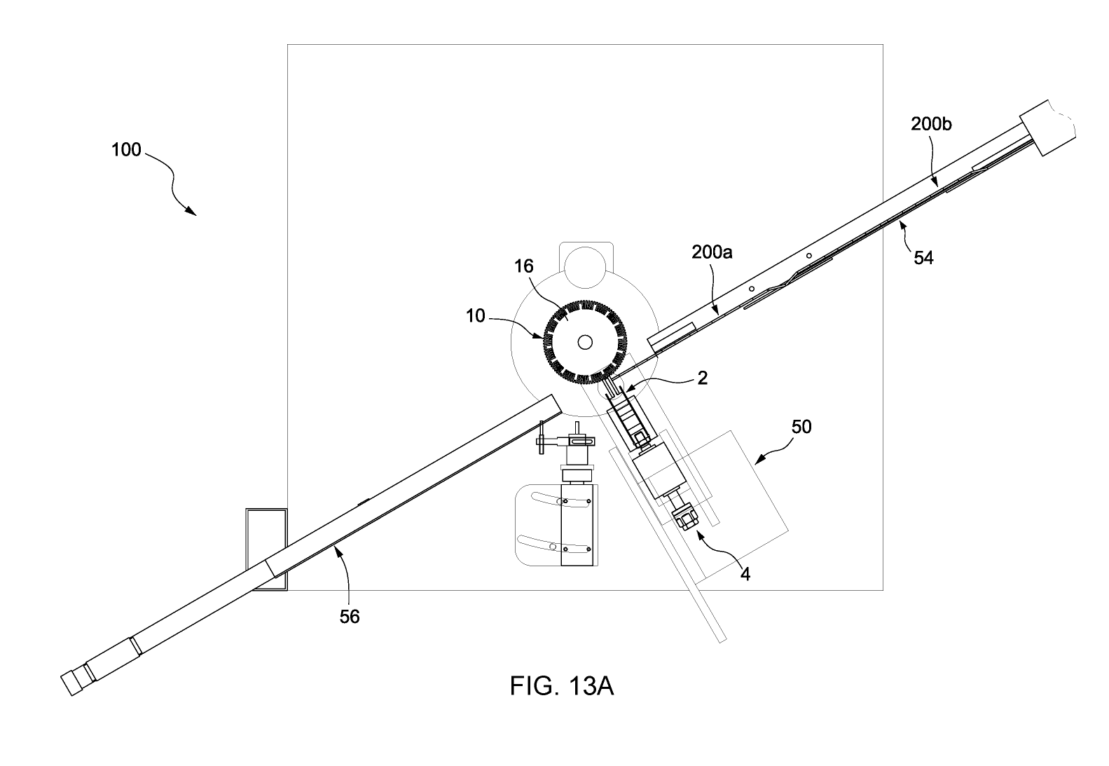

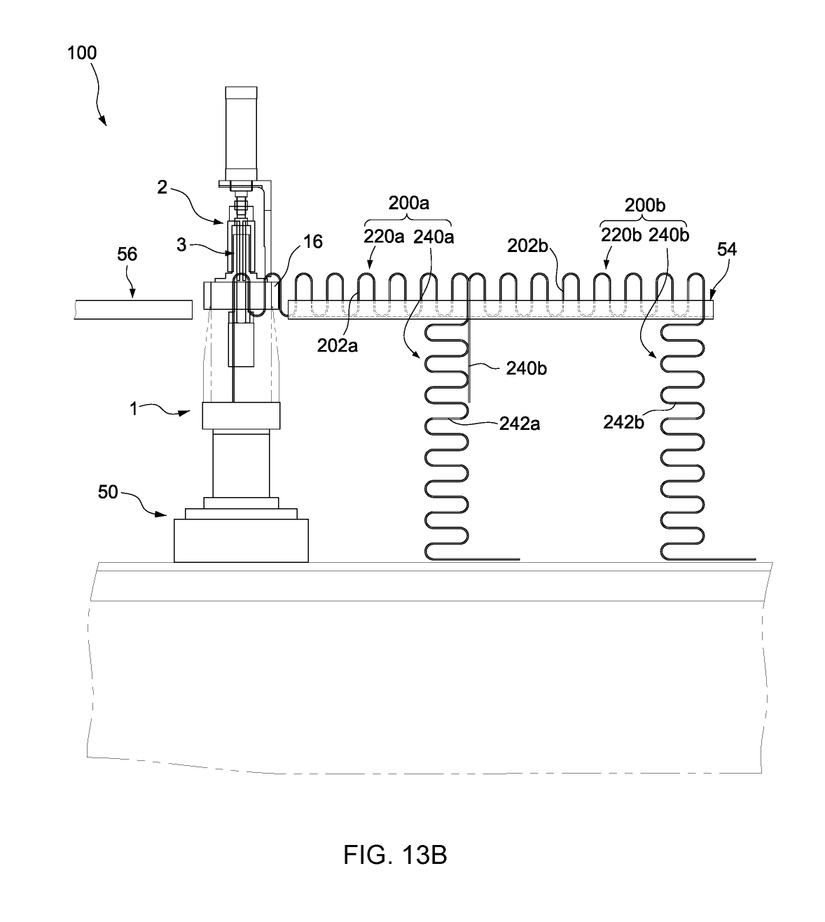

In another embodiment, as shown in FIGS. 13A and 13B, a system 100 is provided to insert a first wire 200a and a second wire 200b into a stator core of an AC generator. By implementing the above-mentioned steps, a first portion 220a of the first wire 200a on the first rail 54 is inserted into slots of the disk 16. Then, a first portion 220b of the second wire 200b on the first rail 54 is inserted into other slots of the disk 16. Next, a third portion 240a of the wire 200a, which is moved to the second rail 56, is inserted into slots of the disk 16. Then, a fourth portion 240b of the second wire 200b, which is also moved to the second rail 56, is inserted into other slots of the disk 16.

In an alternative embodiment, a method for inserting a first wire 200a having a wavy shape and a second wire 200b having a wavy shape into a stator core is provided. The method includes moving the first wire 200a to a side of a rotating receiver 1 having multiple slots 10 so that two first adjacent linear segments 202a of a first portion 220a of the first wire 200a correspond to a first slot and a second slot (not shown) of the slots 10. The distance between the two first linear segments 202a is adjusted so that they are separated by a predetermined interval. The two adjacent first linear segments 202a are inserted into the first slot and the second slot simultaneously. The rotating receiver 1 is rotated in a first rotating direction so that next two first linear segments202a of the first wire 200a correspond to a third slot and a fourth slot of the slots 10. Then the distance between the other first linear segments 202a of the first wire 200a are adjusted before the next first linear segments 202a are inserted into the third and the forth slots (not shown). The second wire 200b is moved to the side of the rotating receiver 1 so that two second linear segments 202b of a second portion 240b of the second wire 200a correspond to a fifth slot and a sixth slot (not shown) of the slots 10. The distance between the two second linear segments 202b is adjusted so that the two second linear segments 202b are separated by the predetermined interval. The two adjacent second linear segments 202b are inserted into the fifth slot and the sixth slot of the slots. The rotating receiver 1 is rotated in the first rotating direction so that next two second linear segments 202b of the second wire 200b correspond to a seventh slot and an eighth slot (not shown) of the slots 10. Then the distance between the next two second linear segments 202b of the second wire 200b are adjusted before the other two second linear segments 202b are inserted into the seventh slot and the eighth slot. Next, a third portion 240a of the first wire 200a is moved to the opposing side of the rotating receiver 1 so that two third linear segments 242a of the third portion 240a of the first wire 200a correspond to the first slot and the second slot. The distance between the two third linear segments 242a is adjusted so that the two third linear segments 242a are separated by the predetermined interval. The two third linear segments 242a are inserted into the first slot and the second slot. The rotating receiver 1 is rotated in a second rotating direction so that next two third linear segments 242a of the first wire 200a correspond to the third slot and the fourth slot. Then, the distance between the next third linear segments 242a are adjusted before the other third linear segments 242a are inserted into their respective slots. A fourth portion 240b of the second wire 200b is moved to the opposing side of the rotating receiver 1 so that two fourth linear segments 242b of the fourth portion 240b of the second wire 200b correspond to the fifth slot and the sixth slot. The distance between the two fourth linear segments 242b is adjusted so that the two fourth linear segments 242b are separated by the predetermined interval. The two fourth linear segments 242b are inserted into the fifth slot and the sixth slot. The rotating receiver 1 in the second rotating direction is rotated so that next two fourth linear segments 242b of the second wire 200b correspond to the seventh slot and the eighth slot. Then, the distance between the other two fourth linear segments 242b are adjusted before the other two fourth linear segments are inserted into respective the seventh slot and the eighth slot. In addition, the first rotating direction is opposite to the second rotating direction.

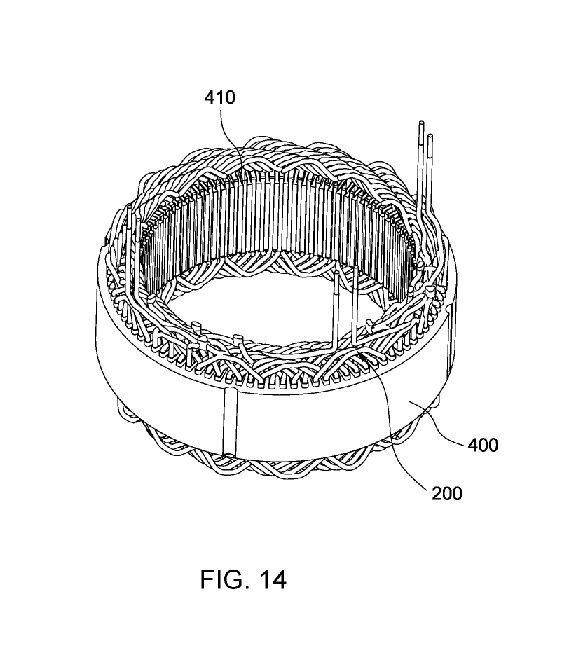

After implementing the aforementioned process for inserting two wires into slots of the disk for several times, the wires 200 (including first wire 200a and second wire 200b) can be removed from the disk 16 into respective slots 410 of a stator core 400, as shown in FIG. 14.

All in all, in accordance with embodiments of the disclosure, wires are automatically adjusted to correspond to slots of the disk before the wires are inserted into the slots. Thus, the step of wire insertion is precisely implemented. In addition, no user or worker is required to implement the aforementioned process, thereby enhancing the manufacture efficiency and reducing cost.

Specific components of an insertion system 100 and related methods for insertion have been described. It should, however, be apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for inserting a wire having a wavy shape into a stator core, the system comprising:
a rotating receiver for rotating around an axis and receiving the wire, the rotating receiver including a plurality of slots circumferentially disposed thereon, the plurality of slots extending along the axis;
a confining component for confining at least two adjacent linear segments of the wire separate within a space defined by the confining component;
an expanding component for adjusting the two adjacent linear segments so that they are separated from each other by a predetermined interval inside the space; and
a pressing component for pressing the two linear segments into two of the plurality of slots.

2. The system of claim 1, wherein the confining component comprises:
two walls, which are separated from each other by a fixed distance; and
a first actuator configured to move the two walls to confine the two linear segments within the space defined by the two walls

3. The system of claim 1, wherein the expanding component comprises:
two expanding plates, which are generally parallel to each other; and
a second actuator configured to move the two expanding plates to adjust the distance between the two adjacent linear segments.

4. The system of claim 3, wherein the expanding component further comprises:
a pin disposed between the two confining plates and configured to be detachably inserted into a slot between the two slots to be inserted by the two linear segments.

5. The system of claim 1, wherein each of the two linear segments is held between one of the two walls and one of the two expanding plates, when the confining component and the expanding component are actuated.

6. The system of claim 1, further comprising:
an adjusting component for adjusting the height of the two linear segments to a predetermined height corresponding to the height of the two slots.

7. The system of claim 6, wherein the adjusting component comprises:
a pivoting portion with a first end pivotally connected to a support and a second end,
a rod disposed on the pivoting portion; and
a third actuator connected to the second end and configured to drive he pivoting portion to pivot about the first end so that the rod raises a curved segmentcurved segment of the wire that connects the two adjacent linear segments.

8. The system of claim 7, wherein the expanding component is provided on the pivoting portion of the adjusting component.

9. The system of claim 1, wherein the wire is defined as a first portion and a second portion that extend in two different directions, respectively, the first portion is inserted into the plurality of slots when the rotating receiver rotates in a first rotating direction, and the second portion is inserted into the plurality of slots when the rotating receiver rotates in a second rotating direction.

10. The system of claim 9, further comprising:
a rotating component for rotating the second portion of the wire so that the second portion of the wire is aligned with the first portion of the wire.

11. The system of claim 9, further comprising:
a first rail for bearing the first portion of the wire; and
a second rail for bearing the second portion of the wire;
wherein the first rail and the second rail are disposed near two opposing sides of the rotating receiver, respectively.

12. The system of claim 11, further comprising:
a pushing component for pushing the wire on the first rail towards the rotating receiver.

13. The system of claim 11, further comprising:
a lifting component for lifting the second rail, the lifting component being configured to move upward or downward; and
a moving component for moving the second rail towards or away from the rotating receiver;
wherein the moving component is disposed on the lifting component.

14. The system of claim 1, wherein the rotating receiver further comprises:
a disk including the plurality of slots; and
a cylinder passing through a through hole of the disk and supporting the disk.

15. The system of claim 14, further comprising:
a holding component detachably holding a free end of the cylinder.

16. The system of claim 14, further comprising:
a lid detachably disposed on a free end the cylinder for housing a stator core corresponding to the disk,
wherein the rotating receiver further comprises an extruding mechanism that has extruding components movable along the plurality of slots to extrude the wire to the corresponding slots of the stator core.

17. The system of claim 1, further comprising:
two blocks disposed on two sides of the confining component and extending towards the rotating receiver for covering the gaps between the confining component and the rotating receiver at the two sides of the confining component.

18. A method for inserting a wire having a wavy shape into a stator core, the method comprising:
moving the wire to a side of a rotating receiver having a plurality of slots so that two adjacent linear segments of the wire correspond to two of the plurality of slots;
adjusting the distance between the two linear segments so that they are separated by a predetermined interval;
inserting the two linear segments into the two slots of the rotating receiver; and
rotating the rotating receiver in a first rotating direction so that another two adjacent linear segments of the wire correspond to other two of the plurality of slots.

19. The method of claim 18, wherein the step of adjusting the distance between the two linear segments comprises:
confining the two linear segments within a space defined by two walls of a confining component; and
expanding the two linear segments by an expanding component having two expanding plates so that each of the two linear segments is hold between one of the two walls of the confining component and one of the two expanding plates..

20. The method of claim 18, wherein the wire is defined as a first portion and a second portion that extend in two different directions, respectively, the method further comprising:
rotating the rotating receiver in a second rotating direction; and
inserting two linear segments of the second portion of the wire into two corresponding slots of the rotating receiver.

21. The method of claim 18, before the step of inserting the two linear segments into two of the plurality of slots, further comprising:
adjusting the two linear segments to a predetermined height;

22. The method of claim 18, further comprising:
extruding the wire, from the plurality of slots, into the corresponding slots of the stator core.

23. A method for inserting a first wire having a wavy shape and a second wire having a wavy shape into a stator core, the method comprising:
moving the first wire to a side of a rotating receiver having a plurality of slots so that two first adjacent linear segments of a first portion of the first wire correspond to a first slot and a second slot of the plurality of slots;
adjusting the distance between the two first linear segments so that they are separated by a predetermined interval;
inserting the two first adjacent linear segments into the first slot and the second slot simultaneously;
rotating the rotating receiver in a first rotating direction so that next two first linear segments of the first wire correspond to a third slot and a fourth slot of the plurality of slots;
moving the second wire to the side of the rotating receiver so that two second linear segments of a second portion of the second wire correspond to a fifth slot and a sixth slot of the plurality of slots;
adjusting the distance between the two second linear segments so that they are separated by the predetermined interval;
inserting the two second adjacent linear segments into the fifth slot and the sixth slot of the plurality of slots; and
rotating the rotating receiver in the first rotating direction so that next two second linear segments of the second wire correspond to a seventh slot and an eighth slot of the plurality of slots.

24. The method of claim 23, further comprising:
moving a third portion of the first wire to the opposing side of the rotating receiver so that two third linear segments of the third portion of the first wire correspond to the first slot and the second slot;
adjusting the distance between the two third linear segments so that they are separated by the predetermined interval;
inserting the two third linear segments into the first slot and the second slot;
rotating the rotating receiver in a second rotating direction so that next two third linear segments of the first wire correspond to the third slot and the fourth slot;
moving a fourth portion of the second to the opposing side of the rotating receiver so that two fourth linear segments of the fourth portion of the second wire correspond to the fifth slot and the sixth slot;
adjusting the distance between the two fourth linear segments so that they are separated by the predetermined interval;
inserting the two fourth linear segments into the fifth slot and the sixth slot; and
rotating the rotating receiver in the second rotating direction so that next two fourth linear segments of the second wire correspond to the seventh slot and the eighth slot;
wherein the first rotating direction is opposite to the second rotating direction.
